(19) United States
(12) Patent Application Publication
(10) Pub. No.: US 2019/0169073 A1
(43) Pub. Date: Jun. 6, 2019

(54) PURIFIED CERAMIC MATERIALS AND METHODS FOR MAKING THE SAME

(71) Applicant: CORNING INCORPORATED, CORNING, NY (US)

(72) Inventors: Monika Backhaus-Ricoult, Bourron, Marlotte (FR); Dana Craig Bookbinder, Corning, NY (US); Richard Fiacco, Corning, NY (US); Thomas Dale Ketcham, Horseheads, NY (US); Paul Maynard Schermerhorn, Paint Post, NY (US)

(21) Appl. No.: 16/303,416

(22) PCT Filed: May 19, 2017
(86) PCT No.: PCT/US2017/033453

§ 371 Date: Nov. 20, 2018

Related U.S. Application Data
(60) Provisional application No. 62/339,224, filed on May 20, 2016.

(51) Int. Cl. C04B 35/486; C04B 35/597; C04B 35/584; C04B 35/565; C04B 35/48; C04B 35/447; C04B 35/185; C04B 35/111; C04B 35/053; C04B 40/00; C03B 17/06

(52) U.S. Cl. CPC C04B 35/486; C04B 2235/3203; C04B 35/584; C04B 35/565; C04B 35/481; C04B 35/447; C04B 35/185; C04B 35/111; C04B 35/053; C04B 40/0007; C03B 17/064; C04B 2235/85; C04B 2235/3206; C04B 2235/3248; C04B 2235/3463; C04B 2235/3826; C04B 2235/3873; C04B 2235/725; C04B 35/597

(57) ABSTRACT

Disclosed herein are ceramic materials comprising a ceramic phase and a glass phase and at least one of a reduced alkali content or a reduced iron content. Ceramic materials having relatively low creep rates are also disclosed herein, as well as glass forming bodies comprising such materials, and methods for making glass articles using such forming bodies. Refractory bricks for constructing glass manufacturing vessels are also disclosed. Methods for treating ceramic materials to reduce at least one of the alkali or iron content are further disclosed herein.

### CROSS-REFERENCE TO RELATED APPLICATIONS

This application claims the benefit of priority under 35 U.S.C. § 119 of U.S. Provisional Application Ser. No. 62/339,224 filed on May 20, 2016, the content of which is relied upon and incorporated herein by reference in its entirety.

### FIELD OF THE DISCLOSURE

The present disclosure relates generally to refractory materials and methods for making the same, and more particularly to treated ceramic materials comprising a ceramic phase and a glass phase, as well as glass forming bodies comprising the same.

### BACKGROUND

High-performance display devices, such as liquid crystal displays (LCDs) and plasma displays, are commonly used in various electronics, such as cell phones, laptops, electronic tablets, televisions, and computer monitors. Currently marketed display devices can employ one or more high-precision glass sheets, for example, as substrates for electronic circuit components, light guide plates, color filters, or cover glasses, to name a few applications. The leading technology for making such high-quality glass substrates is the fusion draw process, developed by Corning Incorporated, and described, e.g., in U.S. Pat. Nos. 3,338,696 and 3,682,609, which are incorporated herein by reference in their entireties.

The fusion draw process typically utilizes a forming body (e.g., isopipe) comprising a trough and a lower portion having a wedge-shaped cross-section with two major forming surfaces sloping downwardly to join at a root. During operation, the trough is filled with molten glass, which is allowed to flow over the trough sides and down along the two forming surfaces as two glass ribbons, which ultimately converge at the root where they fuse together to form a unitary glass ribbon. The glass ribbon can thus have two pristine external surfaces that have not been exposed to the surface of the forming body. The ribbon can then be drawn down and cooled to form a glass sheet having a desired thickness and a pristine surface quality.

Forming bodies used in the glass manufacturing process may be constructed from refractory materials, such as ceramics. Other glass manufacturing vessels, such as furnaces and melters, may also be constructed from refractory materials, e.g., refractory bricks. The life cycle of such forming bodies and vessels can depend on wear of the refractory materials from which they are constructed. For instance, the vessel walls can be gradually worn down due to contact with molten batch materials. Refractory materials used to construct vessels for glass manufacturing should thus exhibit high corrosion resistance, low thermal conductivity, high electric resistivity, and/or high mechanical strength to survive the rigorous temperatures and other conditions associated with processing the molten materials.

Wear of the refractory material during the melting process not only poses a safety risk in terms of creating leakage pathways that can comprise the operational safety of the equipment, but can also contaminate the batch materials. For instance, if a piece of the refractory breaks off into the melt, it may result in an unacceptable impurity or inclusion defect in the final product. Alternatively, if the refractory undesirably reacts with the molten glass, bubbles, inclusions, or other defects can form in the resulting glass sheet, rendering it unsuitable for use. It can therefore be important to utilize refractory materials that can withstand processing rigors for extended periods of time.

Forming bodies tend to be longer in length as compared to their cross-sections and, as such, may sag over time due to the load and high temperature associated with the molten batch materials. The trough sides (or weirs) may likewise deform, for instance, the weirs may spread apart over time due to the molten glass flow. As the forming body sags and/or deforms, it can become increasingly difficult to control the quality and/or thickness of the glass ribbon. Higher temperature operations can accelerate deformation of the forming body due to creep of the refractory material. Creep may be particularly problematic for larger (e.g., longer and/or heavier) forming bodies used to make larger glass sheets, such as Gen-8 (2200×2500 mm) or Gen-10 (2850×3050 mm), leading to an increased likelihood of failure over time.

Consumer demand for high-performance displays with ever growing size and image quality requirements drives the need for improved manufacturing processes for producing large, high-quality, high-precision glass sheets. Accordingly, it would be advantageous to provide refractory materials that can withstand high temperatures and/or corrosive conditions for extended periods of time without compromising safety and/or product quality. It would be also advantageous to provide methods for producing such refractory materials that have reduced cost and/or complexity. Moreover, it would be advantageous to provide refractory materials with a reduced creep rate for making forming bodies or other glass processing vessels having dimensions suitable for constructing large-scale equipment with reduced sag over time.

### SUMMARY

The disclosure relates to ceramic materials comprising a ceramic phase; a glass phase; and at least one of (a) a total alkali content of less than or equal to about 100 ppm by weight or (b) an iron content of less than or equal to about 300 ppm by weight. The disclosure also relates to ceramic materials comprising a ceramic phase; a glass phase; and at least one of (a) a creep rate of less than about 5×10⁻⁷ h⁻¹ at 1180° C. and 1000 psi; (b) a creep rate of less than about 2×10⁻⁶ h⁻¹ at 125° C. and 1000 psi; (c) or a creep rate of less than about 8×10⁻⁶ h⁻¹ at 1300° C. and 625 psi. These ceramic materials can also, in some embodiments, include at least one of the following features:
(1) a total alkali content of less than or equal to about 50 ppm by weight;
(2) a total alkali content of less than or equal to about 20 ppm by weight;
(3) a total alkali content of less than or equal to about 5 ppm by weight;
(4) a total alkali content ranging from about 1 ppm to about 100 ppm by weight;
(5) less than or equal to about 50 ppm by weight of sodium;
(6) less than or equal to about 10 ppm by weight of sodium;
(7) less than or equal to about 5 ppm by weight of sodium;
(8) less than or equal to about 20 ppm by weight of lithium;
(9) less than or equal to about 5 ppm by weight of lithium;
(10) less than or equal to about 1 ppm by weight of lithium;
(11) less than or equal to about 20 ppm by weight of potassium;
(12) less than or equal to about 5 ppm by weight of potassium;
(13) less than or equal to about 1 ppm by weight of potassium;
(14) less than or equal to about 100 ppm by weight of iron;
(15) less than or equal to about 50 ppm by weight of iron;
(16) less than or equal to about 20 ppm by weight of iron;
(17) a total alkaline earth content of less than or equal to about 200 ppm;
(18) a total alkaline earth content of less than or equal to about 100 ppm;
(19) less than or equal to about 100 ppm calcium;
(20) less than or equal to about 100 ppm magnesium;
(21) a weight ratio of silicon to aluminum of at least about 5:1;
(22) a weight ratio of silicon to aluminum of at least about 10:1;
(23) a total content of cations other than silicon and aluminum in the glass phase of less than or equal to about 1 wt %;
(24) from about 2 wt % to about 6 wt % glass phase relative to a total weight of the ceramic material;
(25) a creep rate at 1250° C. and 1000 psi of less than or equal to about 1.5×10⁻⁶ h⁻¹;
(26) a creep rate at 1250° C. and 1000 psi of less than or equal to about 1×10⁻⁶ h⁻¹;
(27) a creep rate at 1250° C. and 1000 psi of less than or equal to about 5×10⁻⁷ h⁻¹;
(28) a creep rate at 1250° C. and 1000 psi of less than or equal to about 1×10⁻⁷ h⁻¹;
(29) a specific electric resistance of at least about 1×10⁴ ohm·cm at 1180° C.;
(30) a specific electric resistance of at least about 1×10⁵ ohm·cm at 1180° C.;
(31) a specific electric resistance of at least about 5×10³ ohm·cm at 1250° C.;
(32) a specific electric resistance of at least about 5×10⁴ ohm·cm at 1250° C.;
(33) a specific electric resistance of at least about 3×10³ ohm·cm at 1300° C.;
(34) a specific electric resistance of at least about 3×10⁴ ohm·cm at 1300° C.;
(35) a ceramic phase comprising a plurality of grains and an intergranular glass phase;
(36) a ceramic phase comprising zircon, zirconia, alumina, magnesium oxide, silicon carbide, silicon nitride, silicon oxynitride, xenotime, monazite, mullite, zeolite, alloys thereof, and combinations thereof;
(37) a ceramic phase comprising zircon or zirconia;
(38) at least one secondary crystalline phase, present in an amount of less than about 5% by volume relative to a total volume of the ceramic material;
(39) from about 0.001 wt % to about 5 wt % of tantalum and/or niobium; and/or
(40) a porosity of less than about 10%.

Further disclosed herein are glass forming bodies comprising such ceramic materials, as well as methods for manufacturing a glass article by introducing molten glass into such a forming body. The molten glass can be chosen, for example, from aluminosilicate, alkali-aluminosilicate, alkaline earth-aluminosilicate, borosilicate, alkali-borosilicate, alkaline earth-borosilicate, alum inoborosilicate, alkali-aluminoborosilicate, and alkaline earth-aluminoborosilicate glasses. Glass articles, e.g., glass sheets or ribbons, produced by these methods can have less than 0.001 bubbles per pound. Refractory bricks for constructing glass manufacturing vessels, such as furnaces and melting tanks, are also disclosed herein.

Still further described herein are methods for treating ceramic materials. According to various embodiments, the methods comprise heating the ceramic body to a treatment temperature; contacting a surface of the ceramic body with an anode; contacting an opposing second surface of the ceramic body with a cathode; and applying an electric field between the anode and cathode to create an electric potential difference across the ceramic body between the anode and cathode. In non-limiting embodiments, the treatment temperature can range from about 1000° C. to about 1500° C., the electric potential difference can range from about 0.1 V/cm to about 20 V/cm, and/or the treatment duration can range from about 1 hour to about 1000 hours. According to further embodiments, the method can comprise removing a portion of the ceramic body adjacent the cathode after applying the electric field.

In yet further embodiments, the treatment methods can comprise heating the ceramic body to a treatment temperature; contacting at least one surface of the ceramic body with at least one halogen-containing compound; and reacting at least one mobile cation present in the glass phase with the at least one halogen-containing compound to produce a treated ceramic material comprising at least one of an alkali content of less than or equal to about 100 ppm by weight or an iron content of less than or equal to about 300 ppm by weight. According to non-limiting embodiments, the treatment temperature can range from about 1000° C. to about 1500° C. and/or the treatment duration can range from about 1 hour to about 1000 hours. The halogen-containing compound can comprise, for example, at least one halogen atom chosen from Br, Cl, or F. A molar ratio of halogen in the halogen-containing compound to total alkali content of the ceramic to be treated can range, in some embodiments, from about 5:1 to about 200:1.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be best understood when read in conjunction with the following drawings, where like structures are indicated with like reference numerals where possible and in which:

FIG. 1A illustrates an exemplary forming body;

FIG. 1B is a cross-sectional view of the forming body of FIG. 1A;

FIG. 2 illustrates an exemplary glass manufacturing system;

FIG. 3 is a schematic illustrating the exemplary movement of mobile ions in a ceramic body under an electric potential difference;

FIG. 4 is a schematic illustrating the exemplary movement of mobile ions in a ceramic body during halogen treatment;

FIG. 5 is a graph depicting creep rate of a ceramic material as a function of alkali concentration;

FIG. 6 is a graph depicting specific electric resistance of a ceramic material as a function of alkali concentration;

FIGS. 7A-B are graphs depicting relative electric resistance as a function of the product of electric field strength and the square root of time for zircon samples;

FIGS. 7C-7D are graphs depicting specific electric resistance as a function of the product of electric field strength and the square root of time for zircon samples;

FIGS. 8A-B are graphs depicting resistance (logarithmic) as a function of the inverse of temperature for zircon samples;

FIGS. 9A-B are an SEM image and EDS spectrum for a glass phase in an untreated zircon (X) sample, respectively;

FIGS. 10A-B are an SEM image and EDS spectrum for a glass phase in a treated zircon (X) anode sample, respectively;

FIGS. 11A-B are an SEM image and EDS spectrum for a glass phase in a treated zircon (X) cathode sample, respectively;

FIGS. 12A-B are SEM images of an untreated zircon (Y) sample;

FIGS. 13A-C are EDS spectra of a ceramic, glass, and tantalate phases in the untreated zircon (Y) sample depicted in FIGS. 12A-B;

FIGS. 14A-C are SEM images of a treated zircon (Y) anode sample;

FIGS. 15A-C are EDS spectra of ceramic, glass, and tantalate phases in the treated zircon (Y) anode sample depicted in FIGS. 14A-C;

FIGS. 16A-C are SEM images of a treated zircon (Y) cathode sample;

FIGS. 17A-C are EDS spectra of ceramic, glass, and tantalate phases in the treated zircon (Y) cathode sample depicted in FIGS. 16A-C;

FIG. 18 is a graph of resistivity versus temperature for some embodiments of the present subject matter;

FIG. 19 is a depiction of a refractory article with all or a portion thereof exposed to exemplary treatment methods; and

FIG. 20 is a depiction of another refractory article with all or a portion thereof exposed to exemplary treatment methods.

### DETAILED DESCRIPTION

Methods

Disclosed herein are methods for treating a ceramic body comprising a ceramic phase and a glass phase, the methods comprising heating the ceramic body to a treatment temperature, contacting a surface of the ceramic body with an anode, contacting an opposing second surface of the ceramic body with a cathode; and applying an electric field between the anode and cathode to create an electric potential difference across the ceramic body between the anode and cathode. Also disclosed herein are methods for treating a ceramic body comprising a ceramic phase and a glass phase comprising at least one mobile cation, the methods comprising heating a ceramic body to a treatment temperature; contacting at least one surface of the ceramic body with at least one halogen-containing compound; and reacting the at least one mobile cation with the at least one halogen-containing compound to produce a treated ceramic material comprising at least one of an alkali content of less than or equal to about 100 ppm by weight or an iron content of less than or equal to about 300 ppm by weight.

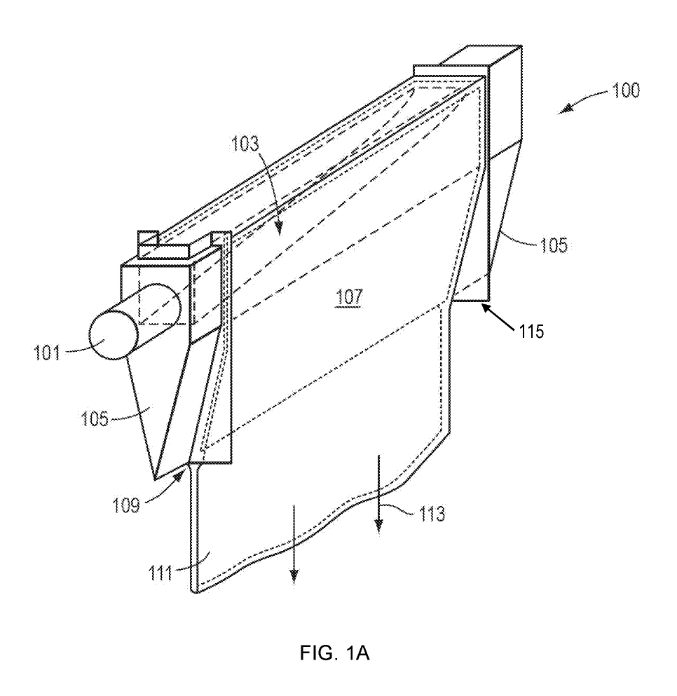

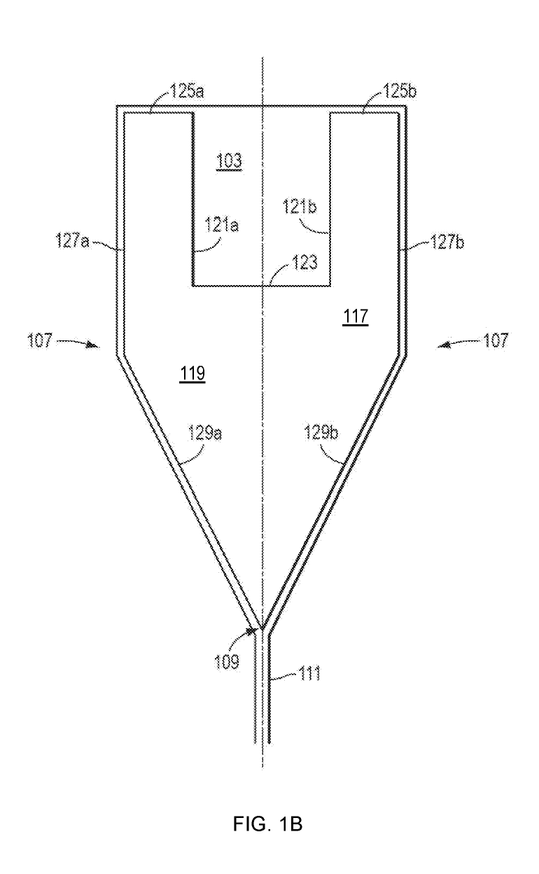

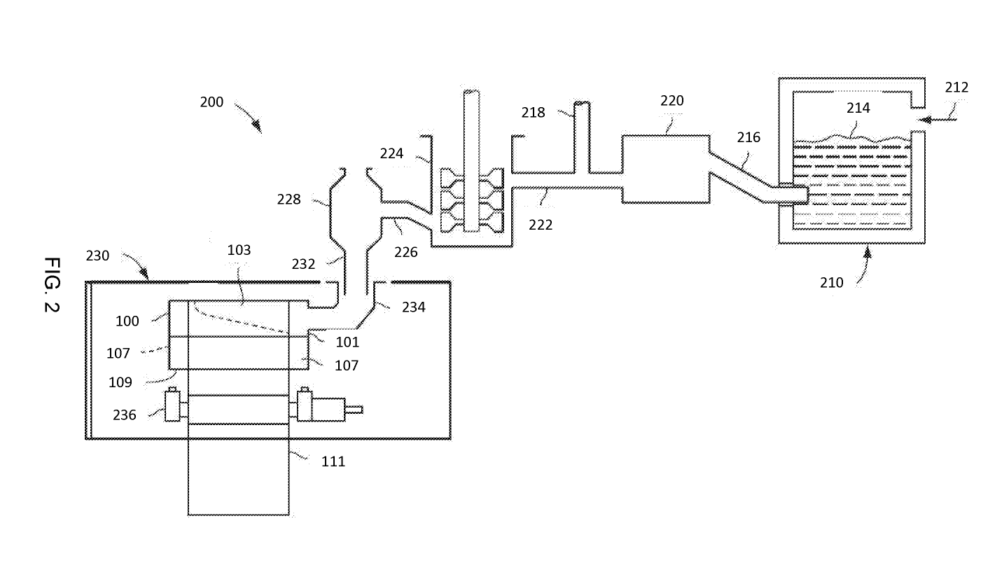

Embodiments of the disclosure will be discussed with reference to FIGS. 1A-B and FIG. 2, which depict an exemplary forming body and glass manufacturing system, respectively. The following general description is intended to provide only an overview of the claimed methods and apparatuses. Various aspects will be more specifically discussed throughout the disclosure with reference to the non-limiting embodiments, these embodiments being interchangeable with one another within the context of the disclosure.

Referring to FIG. 1A, during a glass manufacturing process, such as a fusion draw process, molten glass can be introduced into a forming body 100 comprising a trough 103 via an inlet 101. Once the trough 103 is filled, the molten glass can overflow over the sides of the trough and down the two opposing forming surfaces 107 before fusing together at the root 109 to form a glass ribbon 111. The glass ribbon can then be drawn down in the direction 113 using, e.g., a roller assembly (not shown) and further processed to form a glass sheet. The forming body assembly can further comprise ancillary components such as end caps 105 and/or edge directors 115.

FIG. 1B provides a cross-sectional view of the forming body of FIG. 1A, in which the forming body 100 can comprise an upper trough-shaped portion 117 and a lower wedge-shaped portion 119. The upper trough-shaped part 117 can comprise a channel or trough 103 configured to receive the molten glass. The trough 103 can be defined by two trough walls (or weirs) 125a, 125b comprising interior surfaces 121a, 121b, and a trough bottom 123. Although the trough is depicted as having a rectangular cross-section, with the interior surfaces forming approximately 90-degree angles with the trough bottom, other trough cross-sections are envisioned, as well as other angles between the interior surfaces and the bottom of the trough. The weirs 125a, 125b can further comprise exterior surfaces 127a, 127b which, together with the wedge outer surfaces 129a, 129b, can make up the two opposing forming surfaces 107. Molten glass can flow over the weirs 125a, 125b and down the forming surfaces 107 as two glass ribbons which can then fuse together at the root 109 to form a unitary glass ribbon 111. The ribbon can then be drawn down in direction 113 and, in some embodiments, further processed to form a glass sheet.

The forming body 100 can comprise any material suitable for use in a glass manufacturing process, for example, refractory materials such as zircon, zirconia, alumina, magnesium oxide, silicon carbide, silicon nitride, silicon oxynitride, xenotime, monazite, mullite, zeolite, alloys thereof, and combinations thereof. According to various embodiments, the forming body may comprise a unitary piece, e.g., one piece machined from a single source. In other embodiments, the forming body may comprise two or more pieces bonded, fused, attached, or otherwise coupled together, for instance, the trough-shaped portion and wedge-shaped portion may be two separate pieces comprising the same or different materials. The dimensions of the forming body, including the length, trough depth and width, and wedge height and width, to name a few, can vary depending on the desired application. In some embodiments, at least one dimension, such as the length, of the forming body may be greater than 1 m, greater than 1.5 m, greater than 2 m, or even greater than 2.5 m. It is within the ability of one skilled in the art to select these dimensions as appropriate for a particular manufacturing process or system.

FIG. 2 depicts an exemplary glass manufacturing system 200 for producing a glass ribbon 111. The glass manufacturing system 200 can include a melting vessel 210, a melting to fining tube 216, a fining vessel (e.g., finer tube) 220, a fining to stir chamber connecting tube 222 (with a level probe stand pipe 218 extending therefrom), a stir chamber (e.g., mixing vessel) 224, a stir chamber to bowl connecting tube 226, a bowl (e.g., delivery vessel) 228, a downcomer 232, and a FDM 230, which can include an inlet pipe 234, a forming body (e.g., isopipe) 100, and a pull roll assembly 236.

Glass batch materials can be introduced into the melting vessel 210, as shown by arrow 212, to form molten glass 214. The melting vessel 210 can comprise, in some embodiments, one or more walls constructed from refractory ceramic bricks, e.g., fused zirconia bricks. The fining vessel 220 is connected to the melting vessel 210 by the melting to fining tube 216. The fining vessel 220 can have a high temperature processing area that receives the molten glass from the melting vessel 210 and which can remove bubbles from the molten glass. The fining vessel 220 is connected to the stir chamber 224 by the fining to stir chamber connecting tube 222. The stir chamber 224 is connected to the bowl 228 by the stir chamber to bowl connecting tube 226. The bowl 228 can deliver the molten glass through the downcomer 232 into the FDM 230.

The FDM 230 can include an inlet pipe 234, a forming body 100, and a pull roll assembly 236. The inlet pipe 234 can receive the molten glass from the downcomer 232, from which it can flow to the forming body 100. The forming body 100 can include an inlet 101 that receives the molten glass, which can flow into the trough 103, overflowing over the sides of the trough 103, and running down two opposing forming surfaces 107 before fusing together at the root 109 to form a glass ribbon 111. In certain embodiments, the forming body 100 can be an isopipe comprising a refractory ceramic, e.g., zircon or alumina ceramics. The pull roll assembly 236 can deliver the drawn glass ribbon 111 for further processing by additional optional apparatuses.

For example, a traveling anvil machine (TAM), which can include a mechanical scoring device for scoring the glass ribbon, may be used to separate the ribbon 111 into individual sheets, which can be machined, polished, chemically strengthened, and/or otherwise surface treated, e.g., etched, using various methods and devices known in the art. Of course, while the apparatuses and methods disclosed herein are discussed with reference to fusion draw processes and systems, it is to be understood that such apparatuses and methods can also be used in conjunction with other glass forming processes, such as slot-draw and float processes, to name a few.

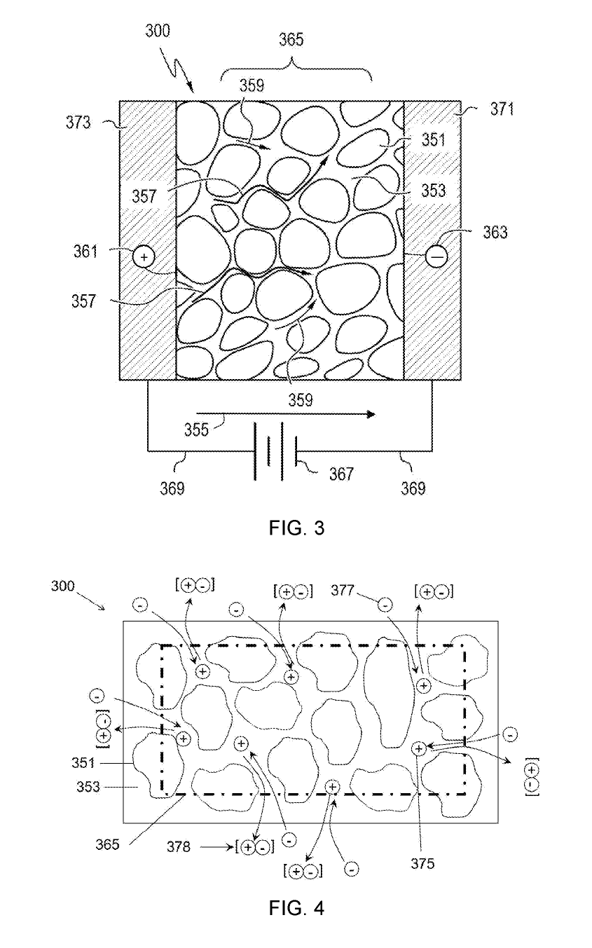

FIG. 3 is a schematic illustrating exemplary migration of mobile ions in a ceramic body 300 under a potential gradient. The ceramic body 300 can include a ceramic phase 351 and a glass phase 353. The ceramic phase 351 may include one or more crystalline phases and/or crystalline grains. The ceramic phase 351 may further include a crystalline matrix or lattice occupied by one or more ions and electrons in a periodic arrangement. The glass phase 353 may be amorphous, e.g., the ions and electrons in the glass phase may not be arranged in a periodic structure. The glass phase 353 may be an intergranular glass phase surrounding one or more grains in the ceramic phase 351. The glass phase 353 may represent a grain boundary region between adjacent grains of the ceramic phase 351.

As used herein, the term “mobile ions” is used to refer to cations and anions that are mobile under a potential gradient, such as an electric field. Exemplary mobile ions include, but are not limited to, lithium (Li⁺), sodium (Na⁺), potassium (K⁺), calcium (Ca²⁺), magnesium (Mg²⁺), iron (Fe³⁺), rare earth metals, and transition metals. Of course, the ceramic material can comprise other mobile ions and/or the listed mobile ions may exist in oxidation states other than those listed.

The chemical composition of the glass phase 353 may include one or more constituents of the ceramic phase 351, and/or may include impurities (or dopants) not present in the ceramic phase. Such impurities may be present in relatively small amounts (e.g., “tramp” or “trace” amounts) and may be introduced intentionally or unintentionally during manufacture of the ceramic body. For instance, a small amount of impurity (or dopant) may be intentionally added to the batch to control a particular condition during the manufacturing process and/or impurities may be unintentionally present in the starting batch materials. Alternatively, impurities may be unintentionally introduced during manufacture of the ceramic body, e.g., by contact with one or more components, such as a shaping mold. Impurities can include, for instance, alkali metals (e.g., Li, Na, K), alkaline earth metals (e.g., Mg, Ca), transition metals (e.g., Fe, Cr, Ti, Mn, Sn), aluminum (Al), and heavy metals (e.g., Ta, W, Mo, V, Nb).

The glass phase 353 may have a melting temperature and/or viscosity lower than that of the ceramic phase 351. For example, depending on the type of mobile ion(s) present in the glass phase, as the ion concentration increases, the melting temperature and/or viscosity of the glass phase 353 may decrease. The melting temperature of a glass phase 353 comprising such impurities may be less than the melting temperature of the ceramic phase 353 by several tens or even hundreds of degrees. As such, the intergranular glass phase 353 may expedite mass transport for densification during high temperature sintering of the forming device 143. As a result, a ceramic body 300 comprising impurities may be densified within a temperature range that is less than a sintering temperature of a chemically pure forming device that does not include any impurities. After removing impurities from the ceramic body, the glass phase may have a higher viscosity at a given temperature, thus lowering mass transport and densification rates, such that the ceramic body has a lower effective creep rate.

Migration of mobile ions under an applied potential gradient may occur at different migration rates due to different mobilities of the individual ion species. In addition, each ion species may possess a variety of individual coupling conditions during migration under the potential gradient that can modify the resulting effective mobility. Until a new steady state is reached for the distribution of the ion species under the applied potential gradient, highly mobile ions may migrate relatively farther and faster than ions possessing low mobility.

Application of a potential gradient may provide, in some instances, sufficient energy for the phase decomposition of the ceramic body into its constituents. For instance, “electrolysis” is used herein to refer to an electrical potential gradient-related, electric energy-assisted phase decomposition of the ceramic material. When the energy locally provided by the electric field remains below the electrolysis threshold, e.g. less than the energy of formation of the ceramic material, the migration of ions in the ceramic material does not induce phase decomposition and leads only to a spatial redistribution of the mobile ions, which is referred to herein as “demixing.” Above the electrolysis threshold, the local energy coupled to the potential gradient may be equal to or greater than the formation energy and may thus lead to the phase decomposition of the ceramic material, e.g., destruction of the crystalline phase and crystal lattice. While the above criterion may describe a thermodynamic bulk balance, the onset of the electrolysis of a material may be delayed due to a need of additional energy for nucleation, interface formation, and overcoming strain energies.

In the ceramic body, mobile ions may migrate under the applied potential gradient toward a negative or positive potential. Different migration mechanisms can be activated, such as, but not limited to, exchanges with point defects such as vacancies or interstitials in ordered crystalline solids or density/fluctuation perturbations that allow migration of more loosely bonded atoms in glassy structures. In the case of potential gradient produced by an electric field, based on charge considerations, cations may migrate toward an area of negative potential while anions may migrate toward an area of positive potential. For example, mobile cations may migrate along the potential gradient from an area of positive potential 361 to an area of negative potential 363 within the ceramic body 300 in the direction illustrated by the arrow 355 in FIG. 3. Cations with higher mobility may migrate faster than cations with lower mobility, as represented by arrows 357 and 359, respectively. As a result, the positive potential area 361 and an interior region 365 of the ceramic body 300 may be relatively depleted of cations with high mobility. Correspondingly, a concentration of the highly mobile ions in the negative potential area 363 may increase.

As illustrated in FIG. 3, opposite sides of the ceramic body 300 may be in direct physical contact with a cathode 371 and anode 373. The operational arrangement of the two electrodes may be configured to apply an electric field having a predetermined magnitude across the ceramic body 300. The two electrodes 371, 373 may be operably coupled to a voltage power supply 367 by lead wires 369. The electric field may be applied to the ceramic body 229 for variable time periods depending, e.g., on the other treatment parameters, such as treatment temperature, until the mobile ions migrate to a region of the ceramic body 300 proximate the cathode 371. In some embodiments, the polarity of the electric field could be inverted during the treatment to drive mobile ions in an opposite direction.

The mobile ions in a ceramic body 300 subjected to an electric field may become enriched in the region proximate the cathode 371. If the cathode 371 comprises a metallic conductor (e.g., Pt, W), without any ionic conductivity for ions, the mobile ions will not migrate into or across the metallic cathode. As a result, the concentration of mobile ions will become enriched in the region proximate the cathode 371. The cation concentration may increase as a function of the duration during which the electric field is applied until a steady state concentration profile is reached. After treating the ceramic body 300 for the desired time period, the region enriched by the mobile ions may be removed or separated from the remainder of the ceramic body, e.g., by mechanically grinding or polishing. The remainder of the treated ceramic body may thus comprise a significantly lower mobile ion concentration as compared to the initial, untreated ceramic body. In some embodiments, if the cathode 371 offers transport paths for the mobile ions, reacts with the mobile ions, and/or dissolves the mobile ions, e.g., in the case of a porous metal-ceramic electrode, then the mobile cations from the ceramic body 300 can be driven into the cathode 371 itself.

The cathode 371 and the anode 373 may include one or more metals, such as, but not limited to, platinum (Pt), nickel (Ni), or tungsten (W). In other embodiments, the cathode 371 and the anode 373 may include carbon (C). In further embodiments, the cathode 371 and the anode 373 may comprise electrically conducting ceramics, such as La-chromite, Ni-lanthanate, TaOₓ, NbOₓ, or WOₓ, alone or in combination with the metallic conductors. In yet further embodiments, the cathode 371 and the anode 373 can comprise electrically conductive carbon, e.g., graphite, carbon nanotubes, or graphene, alone or in combination with the electrically conducting ceramics or the metallic conductors. The cathode 371 and the anode 373 may be formed on the surface(s) of the ceramic body 300 using any number of different forming techniques, including, but not limited to, sputtering, evaporation, atomic layer deposition, chemical vapor deposition, screen printing, spray coating, and various bonding and welding techniques.

An electric potential can be applied across the ceramic body using any method known in the art. For instance, a direct or alternating current can be applied to electrodes on opposing sides of the ceramic body to produce a potential difference across the ceramic body of at least about 0.1 V (per cm of sample thickness). In certain embodiments, the electric potential can range from about 0.1 V to about 20 V, such as from about 0.5 V to about 15 V, from about 1 V to about 12 V, from about 2 V to about 11 V, from about 3 V to about 10 V, from about 4 V to about 9 V, from about 5 V to about 8 V, or from about 6 V to about 7 V, including all ranges and subranges therebetween.

According to non-limiting embodiments, the ceramic body may be heated during application of the electric potential, for instance, the ceramic body may be heated to temperatures greater than or equal to about 1000° C. The treatment temperature can range, in some embodiments, from about 1000° C. to about 1500° C., such as from about 1100° C. to about 1400° C., or from about 1200° C. to about 1300° C., including all ranges and subranges therebetween. The duration of treatment can vary depending, e.g., on the applied voltage and temperature, but can range, in various non-limiting embodiments, from about 1 hour to about 1000 hours or greater, such as from about 10 hours to about 500 hours, from about 20 hours to about 360 hours, from about 30 hours to about 240 hours, from about 40 hours to about 120 hours, from about 50 hours to about 80 hours, or from about 60 hours to about 70 hours, including all ranges and subranges therebetween.

Also disclosed herein are methods for treating a ceramic material comprising a ceramic phase and a glass phase comprising at least one mobile cation, the method comprising heating the ceramic body to a treatment temperature; contacting at least one surface of the ceramic body with at least one halogen-containing compound; and reacting the at least one mobile cation with the at least one halogen-containing compound to produce a treated ceramic material comprising at least one of an alkali content of less than or equal to about 100 ppm by weight or an iron content of less than or equal to about 300 ppm by weight.

Much like the applied potential gradient discussed above, a chemical potential or concentration gradient can also be used, alone or in combination with a charge differential, to promote migration of mobile cations from an interior region to the surface of a ceramic body. Other possible gradients that may promote migration of mobile cations can include temperature or stress gradients.

A chemical potential or concentration gradient can be produced using any number of techniques. For instance, a surface of a ceramic body may be exposed to a layer of solid material having a lower chemical potential or chemical activity for the mobile ions in the ceramic. The mobile ions can thus migrate into the solid layer, e.g., a surface getter layer comprising “clean” ceramics (e.g., with no mobile ions or a lower concentration of mobile ions). Exemplary getter layers can include clean silica, clean zirconia, clean zircon, clean zirconium salts, and the like, which may have a low mobile ion activity. For instance, a solid layer having a low Na activity may be placed in contact with a surface of a ceramic body and, at high temperature, Na may migrate along the grain boundary phase into the getter phase, following the potential gradient. The getter layers may, in certain embodiments, comprise a porous solid, such as a macroporous, mesoporous, or nanoporous solid or fine powder.

A ceramic body surface may also be exposed to a liquid phase having a lower chemical potential for the mobile ion, such that the mobile ions transfer into the liquid phase. The chemical activity of the liquid may, in certain embodiments, be kept at relatively low levels by including a salt-former, e.g., a compound or element that reacts with the mobile ion to form an insoluble salt. Similarly, a ceramic body surface can be exposed to a gas phase having a lower chemical potential for the mobile ion, such that the mobile ions evaporate into the gas phase. The chemical activity of the gas may, in various embodiments, be kept at relatively low levels by including a compound or element that readily reacts with the mobile ion (e.g., in the case of Na, the gas may comprise CI, F, etc.). Dissolution of all or part of the intergranular glass phase of a ceramic may also occur during exposure of the ceramic body to a liquid or gas phase. For instance, Na and other intergranular glass phase constituents may dissolve after prolonged periods of exposure to a halogen-containing compound (e.g., HCl solution or Cl₂ gas, etc.).

Referring to FIG. 4, a ceramic body 300 including a ceramic phase 351 and a glass phase 353 comprising mobile cations 375 can be depleted at its surface (or at inner surfaces for open porosity) by a reaction of mobile cations 375, e.g., Na⁺, Fe³⁺, etc., with at least one halogen-containing compound 377. Cations 375 may migrate due to a chemical potential or concentration differential between an interior (or bulk) region 365 and a surface of the ceramic body 300, e.g., the cations 375 may be drawn to the surface of the ceramic body 300, where they react with the at least one halogen-containing compound 377. The intergranular glass at the surface (or inner surface area) may thus become depleted in the mobile cation as compared to the bulk intergranular glass, which can serve as a driving force for further diffusion of mobile ions in the intergranular glass from the bulk to the surface. As the mobile ions diffuse from the bulk to the surface and react with the halogen-containing compound, the intergranular glass will become further depleted of mobile ions as treatment progresses. Again, migration of mobile ions may occur at different migration rates due to different mobility and/or coupling of the individual ion species.

When the cations 375 reach the surface of the ceramic body 300, they may react with the at least one halogen-containing compound 377 to form a reaction product 378. For instance, in the case of metal cation M⁺ and halide anion X⁻, exemplary reaction complexes can include MₓO_{y}X_{z} or MₓX_{z}, where x, y and z are stoichiometric numbers. These reaction products 378 may be volatile cation-anion complexes capable of diffusing from the surface of the ceramic body into the surrounding atmosphere (e.g., furnace). Cations 375 may also migrate by first having the halogen-containing compound 377 diffuse into the ceramic body (e.g., via open porosity), at which point the halogen-containing compound 377 reacts with one or more mobile cations 375 to form a volatile reaction complex 378. The volatile complex 378 can then diffuse to the surface of the ceramic body and into the surrounding atmosphere. As cations 379 migrate to the surface and react, the interior region 365 of the ceramic body 300 may be relatively depleted of cations as treatment progresses. Gaseous reaction products may be removed, e.g., by air flow or vacuum, to flush the reaction product 378 from the furnace. Any solid reaction products at the surface of the ceramic body can be removed mechanically, e.g., by polishing or grinding, or by washing with water or other solvents. The remainder of the treated ceramic body may thus comprise a significantly lower mobile cation concentration as compared to the initial, untreated ceramic body.

Diffusion in the intergranular phase may accelerate with increasing temperature and thus may be enabled at higher temperature. In non-limiting embodiments, the ceramic body 300 can be heated, e.g., in a furnace or other apparatus, to reduce the viscosity of the glass phase 351 and promote mobility of the cations 375 in the glass phase and/or volatility of the cations through open porosity. Higher temperature may also promote the diffusion of the halogen-containing compound 377 into the ceramic body and/or the volatile reaction product 378 out of the ceramic body. According to non-limiting embodiments, the ceramic body may be heated to temperatures greater than or equal to about 1000° C. The treatment temperature can range, in some embodiments, from about 1000° C. to about 1500° C., such as from about 1100° C. to about 1400° C., or from about 1200° C. to about 1300° C., including all ranges and subranges therebetween. The duration of treatment can vary depending, e.g., on the halide concentration and temperature, but can range, in various non-limiting embodiments, from about 1 hour to about 1000 hours or greater, such as from about 10 hours to about 500 hours, from about 20 hours to about 360 hours, from about 30 hours to about 240 hours, from about 40 hours to about 120 hours, from about 50 hours to about 80 hours, or from about 60 hours to about 70 hours, including all ranges and subranges therebetween.

The ceramic body can be heated to the treatment temperature, in some embodiments, in air or an inert atmosphere prior to contact with the halogen-containing compound. In other embodiments, the ceramic body can be heated to the treatment temperature during contact with the halogen-containing compound. According to various embodiments, the halogen-containing compound can be mixed with one or more carrier liquids or gases to adjust the halide concentration. Exemplary carrier gases can include inert gases, for instance, N₂, Ar, He, Kr, Ne, Xe, and the like. In some embodiments, the halogen-containing compound can be mixed with a non-inert gas, e.g., O₂ or CO, to modify the halogen-containing atmosphere redox state. For example, addition of O₂ may suppress removal of silicon and titanium from the ceramic, whereas the addition of CO may chemically reduce certain mobile cations to a lower oxidation state. For instance, Fe³⁺ may be reduced to Fe²⁺, which can facilitate reaction complex formation between the iron and the halogen-containing compound.

The halogen-containing compound can be combined with the carrier gas in any suitable ratio, for example, from about 9:1 to about 200:1 by volume of carrier to halogen-containing compound, such as from about 20:1 to about 150:1, from about 30:1 to about 100:1, from about 40:1 to about 90:1, from about 50:1 to about 80:1, or from about 60:1 to about 70:1, including all ranges and subranges therebetween. In some embodiments, a concentration of the halogen-containing compound can range from about 0.5% to about 10% by volume relative to a total gas volume, e.g., a gas volume in the furnace. For instance, the halogen-containing compound may have a concentration ranging from about 0.5% to about 9%, from about 1% to about 8%, from about 2% to about 7%, from about 3% to about 6%, or from about 4% to about 5% by volume relative to a total gas volume, including all ranges and subranges therebetween. In additional embodiments, a molar ratio of halogen in the halogen-containing compound to the total alkali content of the ceramic is greater than or equal to about 5:1, such as from about 10:1 to about 200:1, from about 20:1 to about 150:1, from about 30:1 to about 100:1, from about 40:1 to about 90:1, from about 50:1 to about 80:1, or from about 60:1 to about 70:1, including all ranges and subranges therebetween.

Suitable halogen-containing compounds can include any compound from which at least one halide ion can be generated. Exemplary halide ions can include Br⁻, Cl⁻, and F⁻, or combinations thereof. The halogen-containing compound can be a gas or liquid at room temperature and/or at the treatment temperature. In various embodiments, the halogen-containing compound is a gas at the treatment temperature. Non-limiting examples of halogen-containing compounds can include Br₂, Cl₂, and F₂, acids comprising Br, Cl, or F, organic compounds comprising Br, Cl, or F, and combinations thereof, to name a few. Non-limiting examples of such halogen-containing compounds include, for instance, Br₂, CHBr₃, CH₂Br₂, CHBr₃, CBr₄, SiBr₄, SOBr₂, COBr₂, HBr, Cl₂, CHCl₃, CH₂Cl₂, CHCl₃, CCl₄, SiCl₄, SOCl₂, COCl₂, HCl, F₂CHF₃, CH₂F₂, CHF₃, CF₄, SiF₄, SOF₂, COF₂, and HF. According to certain embodiments, the halogen-containing compound may not include elements corresponding to the mobile cations in the glass phase of the ceramic material. For instance, the halogen-containing compound may not comprise one or more of Na, K, Li, Ca, Mg, Ti, Al, Fe, or P, to name a few. Alternatively, the halogen-containing compound may contain such elements, but may not have a chemical potential for the corresponding mobile ion in the same order of magnitude as the ceramic body to be cleaned.

Non-limiting mechanisms for removal of alkali such as lithium by halogen-containing compounds are shown below in Equations 1-5.

2Li2O+SiCl4→4LiCl+SiO2 Eq. 1

Li2O+Cl2→2LiCl+½O2 Eq. 2

2Li2O+CCl4→4LiCl+CO2 Eq. 3

Li2O+SOCl2→2LiCl+SO2 Eq. 4

Li2O+2HCl→2LiCl+H2O Eq. 5

Non-limiting mechanisms for removal of transition metal such as iron by halogen-containing compounds are shown below in Equations 6-10.

2Fe2O3+3SiCl4→4FeCl3+3SiO2 Eq. 6

Fe2O3+6Cl2→2FeCl3+3/2O2 Eq. 7

2Fe2O3+3CCl4→4FeCl3+3CO2 Eq. 8

Fe2O3+3SOCl2→2FeCl3+3SO2 Eq. 9

Fe2O3+6HCl→2FeCl3+3H2O Eq. 10

Methods disclosed herein can be used to treat ceramic materials to reduce the concentration of at least one mobile ion, such as alkali, alkali earth, iron, aluminum, or transition metal ions. In certain embodiments, the alkali content of the treated ceramic material may be at least about 80% reduced as compared to the alkali content of the untreated ceramic material, such as an alkali content reduction of at least about 85%, 90%, 95%, 96%, 97%, 98%, 99%, 99.5%, or 99.9%. The iron content of the treated ceramic material may be similarly reduced by at least about 50%, such as an iron content reduction of at least about 60%, 65%, 70%, 75%, 80%, 85%, 90%, 95%, 99%, or 99.9%. Likewise, an alkaline earth content of the treated ceramic material may be reduced by at least about 40%, such as an alkaline earth content reduction of at least about 45%, 50%, 60%, 65%, 70%, 75%, 80%, 85%, 90%, 95%, 99%, or 99.9%

Further disclosed herein are methods for making a glass article, the methods comprising introducing molten glass into a forming body comprising a treated ceramic material as described herein. Exemplary non-limiting methods for making a glass article are further discussed above with reference to FIGS. 1A-B, which depicts a forming body for use in a glass manufacturing process. Vessels depicted in the glass manufacturing system of FIG. 2 may also be constructed from treated ceramic materials disclosed herein, e.g., refractory bricks. Glass compositions that can be processed according to these methods include both alkali-containing and alkali-free glasses. Non-limiting examples of such glass compositions include, for instance, aluminosilicate, alkali-aluminosilicate, alkaline earth-aluminosilicate, borosilicate, alkali-borosilicate, alkaline earth-borosilicate, alum inoborosilicate, alkali-aluminoborosilicate, and alkaline earth-aluminoborosilicate glasses. In some embodiments, the glass compositions can additionally comprise phosphorous. According to various embodiments, the methods disclosed herein can be used to produce glass sheets, such as high performance display substrates. Exemplary commercial glasses include, but are not limited to, EAGLE XG®, Lotus™, Willow®, Iris™, and Gorilla® glasses from Corning Incorporated.

Glass articles, such as glass ribbons or glass sheets, produced using the methods disclosed herein may have reduced defects as compared to glass articles produced using forming bodies comprising untreated ceramic materials. For example, the methods disclosed herein can provide molten glass and glass articles having less than about 0.001 bubbles per pound, such as less than about 0.0005, or less than about 0.0001 bubbles/pound. “Bubbles” can include air or gas filled cavities in the glass and may be classified by size as “blisters” (larger bubbles) and “seeds” (smaller bubbles). As used herein, a “bubble” may refer to an air or gas filled cavity having a diameter greater than 50 microns.

Ceramic Materials

As used herein, the terms “treated,” “cleaned,” “purified,” and variations thereof are intended to refer to a ceramic material that has been subjected to one or more treatment methods disclosed herein to reduce the concentration of at least one mobile ion within the ceramic. Similarly, “untreated,” “as-processed” and like terms are intended to refer to the ceramic material prior to treatment, e.g., as produced from the batch materials. Treatment can be carried out on the as-processed ceramic material at any point in the manufacture process, e.g., after formation of the ceramic material, after shaping the ceramic material into a desired shape, or after any other desired processing step. Combinations of treatment methods can be used in some embodiments.

In non-limiting embodiments, the creep rate of a material sample can be measured, for example, by conducting a three-point bending test while the sample is exposed to given temperature and pressure. Electric resistance of a material can be calculated, for instance, by attaching electrodes to opposite faces of the material and applying voltage at a given temperature while taking impedance measurements (e.g., using a Solartron 1260). According to various embodiments, bubbles in a glass article, such as a glass sheet, can be measured by visually assessing the article and counting the number of bubbles in the sheet. Bubbles per pound can be calculated by dividing the number of bubbles in the sheet by its weight. Porosity of a ceramic sample may be measured, for example, by mercury intrusion porosimetry.

The methods disclosed herein may provide ceramic materials, such as refractory ceramic materials, having low impurity levels not previously attainable via prior art methods. As a result of the low impurity levels, such as low alkali levels, it was unexpectedly discovered that the ceramic materials exhibit lower creep rates than currently available commercial ceramics. Reducing the concentration of cations in the ceramic material may also provide for an intergranular glass phase having a higher viscosity, which can result in a ceramic material with a lower ion transport rate, such that the ceramic material may have a lower initial corrosion rate during processing of molten materials such as glass.

The treated ceramic materials disclosed herein can provide various advantages for processing alkali-containing glasses. Alkali-containing glasses, e.g., alkali aluminosilicate glasses, may be prone to fusion line blister formation, which can produce defects in the resulting glass sheet, rendering it unsuitable for use as a high-quality glass substrate, e.g., in display applications. As such, it may not be currently feasible to process alkali-containing glasses using vessels constructed from commercially available materials because such materials tend to promote fusion line blister formation in the glass for a lengthy start-up period (e.g., >1-2 weeks). It can be costly and wasteful to discard large quantities of defective product during this start-up period. While antimony can be added to the glass composition to reduce fusion line blister formation, it is generally desirable to reduce or eliminate the amount of antimony in the manufacturing process and resulting product, as antimony is a heavy metal element that poses potential environmental hazards. The removal of cations, such as variable valence cations (e.g., Fe, Ti), using the methods disclosed herein may thus provide ceramic materials with a lower propensity for producing fusion line blisters when processing alkali-containing glass materials, without the addition of environmentally hazardous materials. Of course, it is to be understood that the methods and materials disclosed herein may not have one or more of the above advantages, but are intended to fall within the scope of the appended claims.

The creep mechanism for single-phase ceramics can be either Coble creep (grain boundary diffusion) or Nabarro-Herring creep (lattice diffusion). When a ceramic material comprises multiple phases, e.g., a ceramic phase and a glass phase, the material may have an enhanced diffusion coefficient for ions in the glass phase, e.g., at the grain boundaries. The multi-phase ceramic may thus follow a modified Coble creep equation, in which the grain boundary thickness is replaced by the thickness of the glass phase at the grain boundary, the grain boundary diffusion coefficient is replaced by the diffusion coefficient of the ion in the glass phase.

Creep can occur, in some situations, due to viscous flow of the glass phase within the microstructure of the ceramic material, e.g., the glass may flow from compressive grain boundaries to tensile grain boundaries. Depending on the porosity of the material, the ceramic phase and/or the glass phase can move from compressive grain boundaries to regions of porosity, or the glass phase can move from regions of porosity to tensile grain boundaries. In any of these cases, removing mobile cations (other than Si) from the glass phase may increase the viscosity of the glass phase, causing the glass to flow more slowly, which can consequently reduce the strain relaxation rate of the glass. Additionally, removing mobile cations from the glass phase can reduce the overall diffusivity of the glass at the grain boundaries, including diffusion of the ceramic phase constituents (e.g., Zr, Si, O in the case of zircon). Reducing the diffusion coefficient of the grain constituents can slow mass transport at a given temperature, which can consequently reduce the creep rate.

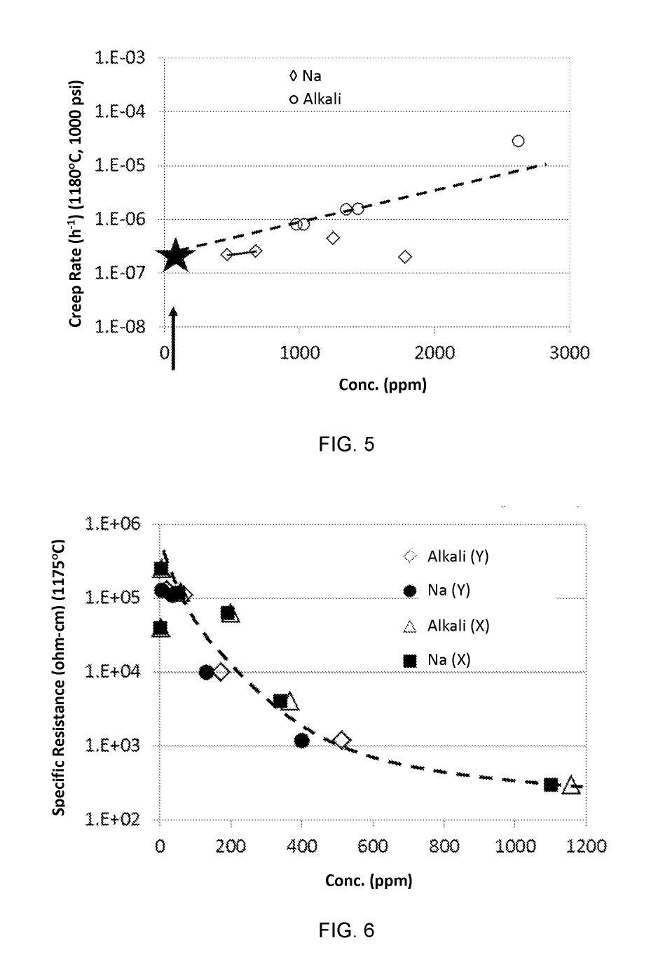

FIG. 5 is a graph illustrating creep rate of a ceramic material measured by a three-point bending test at 1180° C. and 1000 psi as a function of alkali (circles) and sodium (diamond) concentration for zircon ceramic samples. Similarly, FIG. 6 is a graph illustrating specific resistance of two different zircon ceramic samples at 1175° C. as a function of sodium or alkali concentration. As shown in FIG. 5, Applicant has unexpectedly discovered that the creep rate of a ceramic material decreases as alkali concentration decreases. Applicant has also discovered a corresponding increase in the specific electric resistance of the ceramic material, as can be observed in FIG. 6. As such, by reducing the alkali impurity levels in a ceramic material using the methods disclosed herein, it can be possible to produce treated ceramic materials having surprisingly high electric resistance, surprisingly low creep rate, or both. Reducing the alkali impurity levels in the ceramic material can also provide the added benefit of lowering the rate of corrosion of the ceramic material over time. For example, the corrosion rate of an untreated ceramic material may be at least twice as high as that of an untreated ceramic material, such as 3 times, 4 times, or 5 times as high.

The treated ceramic materials disclosed herein can comprise a ceramic phase, a glass phase, and at least one of (a) a total alkali content less than or equal to about 100 ppm by weight or (b) an iron content of less than or equal to about 300 ppm. The treated ceramic materials can also comprise at least one of (a) a creep rate of less than about 5×10⁻⁷ h⁻¹ at 1180° C. and 1000 psi, (b) a creep rate of less than about 2×10⁻⁶ h⁻¹ at 1250° C. and 1000 psi, or (c) a creep rate of less than about 8×10⁻⁶ h⁻¹ at 1300° C. and 625 psi.

Concentrations disclosed herein are provided for the overall ceramic material, e.g., based on a total weight of the ceramic material, unless expressly stated otherwise. While a described mobile ion (e.g., Na⁺) may be present primarily in the glass phase of the ceramic, the mobile ion concentration is provided for the overall ceramic material (ceramic phase+glass phase). The local concentration of the mobile ion(s) may be much greater in the glass phase, e.g., up to about 100 times greater, such as about 50 times, 25 times, 10 times, 5 times, 3 times or 2 times greater than the overall concentration. For instance, an alkali content of 100 ppm in the overall ceramic material may correspond to a local glass phase alkali concentration of up to about 1 wt %. Localized concentrations in the intergranular glass can be calculated by dividing the overall concentration by the weight percent of glass phase present. By way of a non-limiting example, an overall ceramic material comprising a 60 ppm alkali content and 3 wt % glass phase can have a localized alkali concentration in the glass phase of up to about 0.2 wt %. Localized concentrations for other components, their relative amounts, and the relative amount of glass phase can be similarly calculated for each of the overall concentrations below and are intended to fall within the scope of the disclosure.

In certain embodiments, the total alkali content can be less than or equal to about 100 ppm, such as less than or equal to about 50 ppm, less than or equal to about 40 ppm, less than or equal to about 30 ppm, less than or equal to about 20 ppm, less than or equal to about 10 ppm, less than or equal to about 5 ppm, or less than or equal to about 1 ppm by weight, e.g., ranging from about 1 ppm to about 100 ppm, including all ranges and subranges therebetween. Similarly, the iron content can be less than or equal to about 300 ppm, such as less than or equal to about 200 ppm, less than or equal to about 100 ppm, less than or equal to about 50 ppm, less than or equal to about 40 ppm, less than or equal to about 30 ppm, less than or equal to about 20 ppm, or less than or equal to about 10 ppm by weight, e.g., ranging from about 10 ppm to about 300 ppm, including all ranges and subranges therebetween.

Exemplary mobile cations in the ceramic material include alkali metals (e.g., Li, Na, K). The concentration(s) of these metals can, in various embodiments, be reduced using the treatment methods disclosed herein. For instance, a treated ceramic material can comprise less than about 100 ppm by weight of sodium, such as less than or equal to about 50 ppm, less than or equal to about 40 ppm, less than or equal to about 30 ppm, less than or equal to about 20 ppm, less than or equal to about 10 ppm, less than or equal to about 5 ppm, or less than or equal to about 1 ppm by weight, e.g., ranging from about 1 ppm to about 100 ppm, including all ranges and subranges therebetween. Likewise, a treated ceramic material can comprise less than about 100 ppm by weight of lithium or potassium, such as less than or equal to about 50 ppm, less than or equal to about 40 ppm, less than or equal to about 30 ppm, less than or equal to about 20 ppm, less than or equal to about 10 ppm, less than or equal to about 5 ppm, or less than or equal to about 1 ppm by weight, e.g., ranging from about 1 ppm to about 100 ppm, including all ranges and subranges therebetween.

In additional embodiments, the concentration(s) of alkaline earth metals (e.g., Mg, Ca) can be reduced using the treatment methods disclosed herein. For instance, a treated ceramic material can have a total alkaline earth content of less than or equal to about 200 ppm by weight, such as less than or equal to about 150 ppm, less than or equal to about 100 ppm, or less than or equal to about 50 ppm by weight, e.g., ranging from about 50 ppm to about 200 ppm, including all ranges and subranges therebetween. In certain embodiments, a treated ceramic material can comprise less than or equal to about 100 ppm by weight of calcium, such as less than or equal to about 50 ppm, or less than or equal to about 25 ppm by weight, e.g., ranging from about 25 ppm to about 100 ppm, including all ranges and subranges therebetween. Similarly, a treated ceramic material can comprise less than or equal to about 100 ppm by weight of magnesium, such as less than or equal to about 50 ppm, or less than or equal to about 30 ppm by weight, e.g., ranging from about 30 ppm to about 100 ppm, including all ranges and subranges therebetween.

In certain embodiments, the treatment methods disclosed herein can also reduce the amount of aluminum present in the glass phase. For instance, a weight ratio of silicon to aluminum in the glass phase of a treated ceramic material can be at least about 5:1, at least about 6:1, at least about 7:1, at least about 8:1, at least about 9:1, at least about 10:1, or greater, e.g., ranging from about 5:1 to about 10:1, including all ranges and subranges therebetween. Other than silicon and aluminum, the glass phase may be, in non-limiting embodiments, substantially depleted of cations. For instance, the glass phase can comprise a total content of cations other than silicon and aluminum that is less than about 1 wt %, such as less than about 0.5 wt %, less than about 0.2 wt %, or less than about 0.1 wt %, e.g., ranging from about 0.1 wt % to about 1 wt %, including all ranges and subranges therebetween.

Ceramic materials disclosed herein may be relatively dense, e.g., having a porosity of less than about 20%, such as less than about 10%, less than about 9%, less than about 8%, less than about 7%, less than about 6%, less than about 5%, less than about 4%, less than about 3%, less than about 2%, or less than about 1%, e.g., ranging from about 0.1% to about 20%, or from about 1% to about 10%, including all ranges and subranges therebetween. The ceramic materials may, in certain embodiments, have interconnected (“open”) porosity. Exemplary ceramic materials include, but are not limited to, zircon, zirconia, alumina, magnesium oxide, silicon carbide, silicon nitride, silicon oxynitride, xenotime, monazite, mullite, zeolite, alloys thereof, and combinations thereof. In certain embodiments, the ceramic material comprises zircon or zirconia. The ceramic phase can comprise a plurality of grains, and these grains can be at least partially surrounded by the glass phase, e.g., an intergranular or grain boundary glass phase.

The ceramic phase can further comprise at least one secondary crystalline phase, present in an amount of less than about 5% by volume relative to a total volume of the ceramic material, such as less than about 4%, less than about 3%, less than about 2%, less than about 1%, less than about 0.5%, or less than about 0.1% by volume, e.g., ranging from about 0.1% to about 5% by volume, including all ranges and subranges therebetween. An exemplary secondary crystalline phase can comprise tantalum, which may be present in the ceramic material in an amount ranging from about 0.001 wt % to about 5 wt %, such as from about 0.01 wt % to about 2 wt %, from about 0.1 wt % to about 1 wt %, or from about 0.3 wt % to about 0.5 wt %, relative to a total weight of the ceramic material, including all ranges and subranges therebetween. Niobium may also be present in the ceramic material in an amount ranging from about 0.001 wt % to about 5 wt %, such as from about 0.01 wt % to about 2 wt %, from about 0.1 wt % to about 1 wt %, or from about 0.3 wt % to about 0.5 wt %, relative to a total weight of the ceramic material, including all ranges and subranges therebetween.

In certain embodiments, the glass phase can make up about 10 wt % or less of the ceramic material, e.g., the ceramic material can comprise from about 1 wt % to about 10 wt % of glass phase, such as from about 2 wt % to about 9 wt %, from about 3 wt % to about 8 wt %, from about 4 wt % to about 7 wt %, or from about 5 wt % to about 6 wt %, including all ranges and subranges therebetween. According to a non-limiting embodiment, the glass phase can make up from about 2 wt % to about 6 wt % of the ceramic material. A localized alkali concentration in the glass phase can be less than or equal to about 1 wt %, e.g., ranging from about 10 ppm to about 1 wt %. Localized concentrations of sodium, lithium, and/or potassium in the glass phase can similarly range from about 10 ppm to about 1 wt %. A localized iron concentration can be less than or equal to about 3 wt %, e.g., ranging from about 0.01 wt % to about 3 wt %. A localized alkaline earth concentration in the glass phase can be less than or equal to about 2 wt %, e.g., ranging from about 0.05 wt % to about 2 wt %. Localized concentrations of calcium and/or magnesium can likewise range from about 0.025 wt % to about 1 wt %.

Ceramic materials disclosed herein can have reduced creep rates as compared to prior art ceramic materials. For instance, a treated ceramic material can have at least one of a creep rate of less than about 5×10⁻⁷ h⁻¹ at 1180° C. and 1000 psi, a creep rate of less than about 2×10⁻⁶ h⁻¹ at 1250° C. and 1000 psi, or a creep rate of less than about 8×10⁻⁶ h⁻¹ at 1300° C. and 625 psi. In various embodiments, at 1250° C. and 1000 psi, the creep rate can be less than or equal to about 1.5×10⁻⁶ h⁻¹, less than or equal to about 1×10⁻⁶ h⁻¹, less than or equal to about 5×10⁻⁷ h⁻¹, less than or equal to about 1×10⁻⁷ h⁻¹, or even lower. At 1180° C. and 1000 psi, the creep rate can be less than or equal to about 4×10⁻⁷ h⁻¹, less than or equal to about 3×10⁻⁷ h⁻¹, less than or equal to about 2×10⁻⁷ h⁻¹, less than or equal to about 1×10⁻⁷ h⁻¹, or even lower. At 1300° C. and 625 psi, the creep rate can be less than or equal to about 5×10⁻⁶ h⁻¹, less than or equal to about 2×10⁻⁶ h⁻¹, less than or equal to about 1×10⁻⁶ h⁻¹, less than or equal to about 5×10⁻⁷ h⁻¹, or even lower.

Ceramic materials disclosed herein can also have increase electric resistance as compared to prior art ceramic materials. For instance, a treated ceramic material can have at least one of a specific electric resistance of at least about 1×10⁴ ohm·cm at 1180° C., a specific electric resistance of at least about 5×10³ ohm·cm at 1250° C., or a specific electric resistance of at least about 3×10³ ohm·cm at 1300° C. In additional embodiments, the treated ceramic material can have at least one of a specific electric resistance of at least about 1×10⁵ ohm·cm at 1180° C., a specific electric resistance of at least about 5×10⁴ ohm·cm at 1250° C., or a specific electric resistance of at least about 3×10⁴ ohm·cm at 1300° C.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a component” includes examples having two or more such components unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

### Example 1

Ceramic bodies of various sizes were produced from two different zircon materials (X and Y). Whereas X zircon materials do not comprise a significant amount of tantalum, Y zircon materials were observed to contain tantalum precipitates. Electrodes were formed on opposite sides of the samples (ceramic surfaces roughened to about 50 mesh) by screen printing a thin layer of 50:50 Pt/3YSZ ink with approximately 50% solid loading. The samples were sintered at 1100-1200° C. for 1-2 hours in air. A strip of Pt gauze and two Pt connection wires were applied to both sides of the sample, allowing for four-point measurements for each sample. The samples were mounted on a support plate with a thermocouple located close to the sample and introduced into a furnace. Temperature, applied voltage, induced current, and resistance were continuously monitored.

The complex impedance of various samples was measured as a function of time to monitor “cleaning” progress. A Solartron system with 1260 Frequency Response Analyzer and 1287 Electrochemical Interface was used for acquisition of impedance, i-V and i-t under applied voltage. The frequency was varied from 0.1 Hz to 300,000 Hz during impedance acquisition. The amplitude applied between working and reference electrode was 20 mV. Twenty points per decade of frequency were measured while scanning from the highest to the lowest frequency. The different contributions were fitted by an equivalent circuit comprising a set of parallel resistance and constant phase elements for all observed arcs. Additional diffusion resistances or other additional circuit elements were not needed for a good fit.

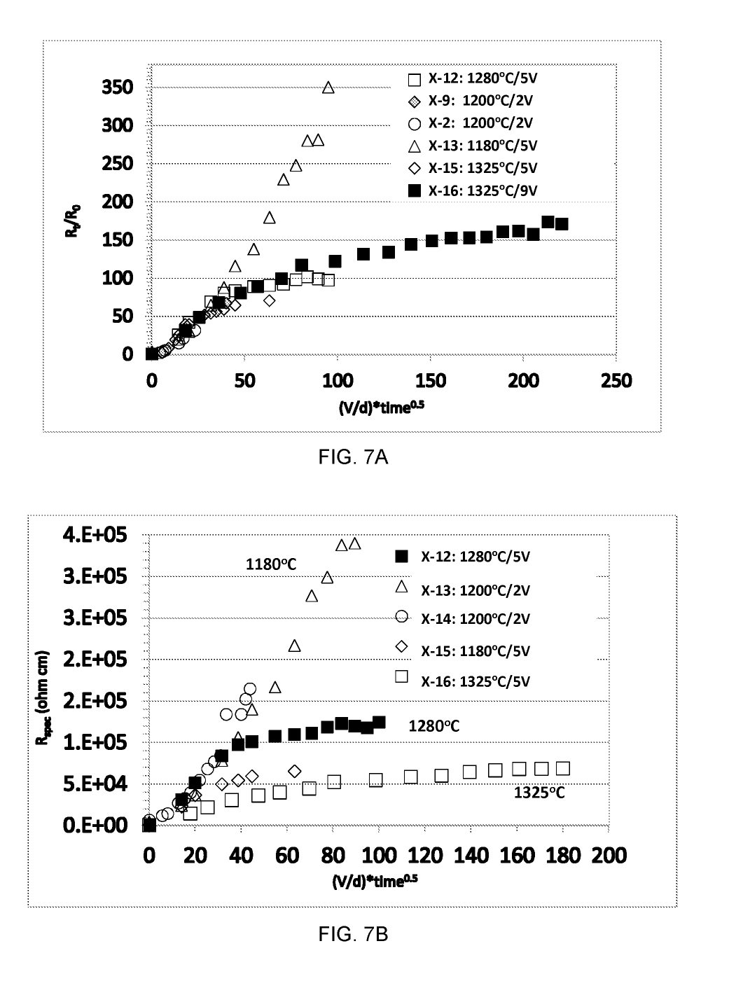

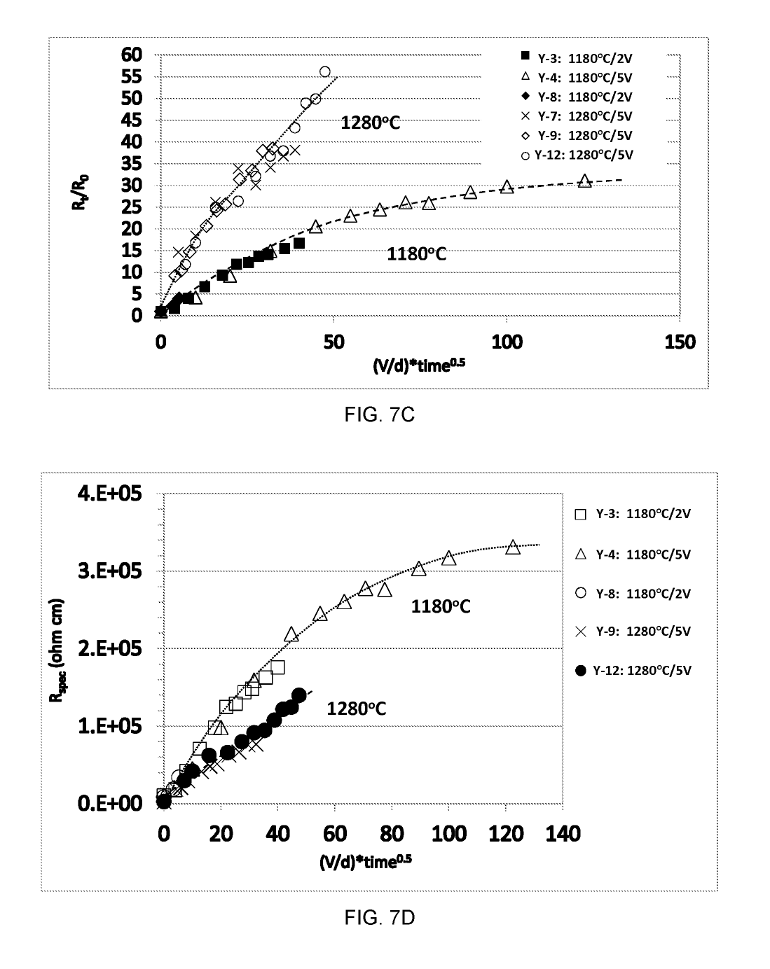

FIG. 7A is a graph of the relative increase in electric resistance (Rₜ/R₀) as a function of the product of electric field strength (V/d, V=voltage, d=sample thickness) and the square root of time (h^{0.5}) for X samples. The samples had various surface area and thickness ranging from 0.5 cm×1 cm×1 cm, 0.5 cm×1 cm×2 cm, 1 cm×3 cm×16 cm, 3 cm×1 cm×16 cm) and were exposed to an electric potential difference of 2-9V (across the first indicated side) at temperatures between 1100-1300° C. After an initial sluggish start phase, the curves follow a parabolic rate law, indicating diffusion-controlled process scaling with the square root of time. At higher treatment temperatures, the treated electrical resistance (Rₜ) increases more steeply relative to the initial electrical resistance (R₀), indicating that increased temperatures may provide for more rapid cleaning of the ceramic body. The behavior can be normalized on the applied electric field. For instance, FIG. 7B plots the specific resistance as function of the product of electric field strength and the square root of time. Samples with different surface sizes and thicknesses were observed to exhibit similar behavior.

FIG. 7C is a graph of the relative increase in electric resistance (Rₜ/R₀) as a function of the square root of time (h) for Y samples of various sample size and thickness exposed to an electric potential difference of 2V or 5V at temperatures between 1100-1300° C. The curves initially follow a parabolic rate law, indicating diffusion-controlled process scaling with the square root of time. When approaching a fully cleaned state, the kinetics slow down and evolve slowly towards the final state, but the curve thereafter adopts slower kinetics. In this final cleaning state, it is believed that the tantalate precipitates in the Y samples are dissolved into the glass phase such that their ions participate in the driven diffusion. At higher electric field strengths, the treated electrical resistance (Rₜ) increases more steeply relative to the initial electrical resistance (R₀), indicating that increased potential difference may provide for more rapid cleaning of the ceramic body. At higher temperature, kinetics are also faster. The behavior can be normalized on the applied electric field. For instance, FIG. 7D, which plots the specific resistance as function of the product of electric field strength and the square root of time. Samples with different surface sizes and thicknesses were observed to exhibit similar behavior. If desired, the kinetic curves for different temperatures can be combined into a single unique master plot with temperature input and a temperature-dependent activation energy.

Table I below summarizes the relative increase in electric resistance (Rₜ/R₀) for various Y samples. It was observed that sample resistance increased in all cases by at least a factor of 10, and in many cases by a factor of more than 20, and even as high as a factor of 38.

TABLE I
Electric Resistance of Treated Y Samples

| Sample | Size (cm) | Temp. (° C.) | Voltage (V) | Time (h) | Rₜ/R₀ |
|---|---|---|---|---|---|
| Y-1 | 0.5 × 1 × 2 | 1200 | 2 | 60 | 13.4 |
| Y-2 | 0.5 × 1 × 2 | 1300 | 2 | 100 | 18.6 |
| Y-3 | 0.5 × 1 × 2 | 1200 | 2 | 100 | 16.7 |
| Y-4 | 0.5 × 1 × 2 | 1200 | 5 | 150 | 31.1 |
| Y-5 | 0.5 × 1 × 2 | 1200 | 5 | 20 | 20 |
| Y-6 | 0.5 × 1 × 2 | 1200 | 8 | 150 | 28 |
| Y-7 | 1 × 3 × 17 | 1300 | 5 | 50 | 38 |
| Y-8 | 1 × 3 × 17 | 1300 | 5 | 50 | — |

### Example 2

X samples were subjected to electrical fields of 2-20 V/cm, at temperatures of 1100-1350° C., for time periods of up to 200 hours. Y samples were subjected to electrical fields of 1-9 V/cm, at temperatures of 1200-1350° C., for time periods of up to 200 hours. After the samples achieved a desired level of electric resistance, the samples were quenched under applied electric field and cut into “clean” anode samples (e.g., 6 mm from a 10 mm thickness) and “enriched” cathode samples (e.g., 3 mm from a 10 mm thickness). The anode samples were observed to be homogeneous in color. In contrast, a region of each sample proximate the cathode was observed to be white in coloration, which may be due to cation enrichment. For X samples the region was approximately 1 mm wide, whereas for Y samples the region was approximately 0.1 mm wide. After treatment at high temperature and high field strength, for example 13500C, 20V/cm, the cathode side of the samples developed two enrichment bands, an outer white band (extremely rich in alkali) and an orange band (rich in iron, calcium and titanium). In some instances, the orange band contained intergranular crystalline pockets of Ti(Fe)O₂.

Platinum electric contacts were provided for each of the anode and cathode samples and the impedance of each treated X and Y anode/cathode sample was measured as a function of temperatures ranging from 500-1350° C. in air and compared to untreated X and Y samples. Impedance was measured at each chosen temperature after temperature equilibration. The impedance arc corresponding to grain boundary transport was identified and resistance and capacitance for the grain boundary were extracted. In general, it was also observed that the cathode portion of the treated samples had a lower electric resistance than the anode portion.

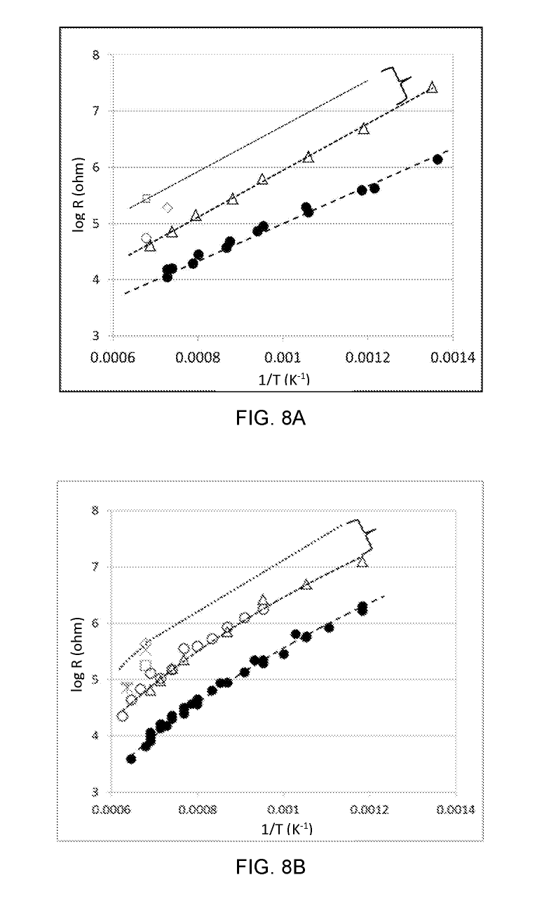

Electric resistance in ohm (logarithmic) of treated (open symbols) and untreated (solid circles) X samples is presented in FIG. 8A as a function of the inverse of temperature (K⁻¹). The treated X sample represented by the open triangles was measured as a function of different temperatures, whereas the other treated X samples (open circle, open diamond, open square) were only measured at high temperature. Dashed trend lines demonstrate a region of improved electric resistance obtainable by exemplary methods disclosed herein. Depending on the treatment parameters measured, the treated X samples had approximately 5-100 times higher resistance as compared to the untreated X sample. The treated X materials exhibited a higher activation energy than the untreated materials, this increase possibly being related to a higher viscosity of the grain boundary phase and the resulting larger energy barrier for ion transport.

Electric resistance in ohm (logarithmic) of treated (open symbols) and untreated (solid circles) Y samples is presented in FIG. 8B as a function of the inverse of temperature (K⁻¹). The treated Y samples represented by the open circles and open triangles were measured as a function of different temperatures, whereas the other treated Y samples (open square, open diamond, star, cross, bar) were only measured at high temperature. Dashed trend lines demonstrate a region of improved electric resistance obtainable by exemplary methods disclosed herein. For the parameters measured, the treated Y samples had approximately 10-60 times higher resistance as compared to the untreated Y sample, although higher resistances may be attainable using other treatment parameters. Both the treated and untreated Y samples exhibited a change in activation energy as a function of temperature at about 1100° C., which may suggest a change in the dominant transport mechanism around this temperature. It is thus possible that sample Y could have similar grain boundary transport resistance as sample X at higher temperatures.

Upon comparing FIGS. 8A-B, it was observed that the untreated Y sample had a resistance substantially higher than (nearly twice) that of the untreated X sample in the low- to mid-temperature range. However, treated X and Y samples exhibited the same resistance, indicating that the advantage of the untreated Y material over the untreated X material is not preserved after treatment. While not wishing to be bound by theory, it is believed that tantalate precipitates in the intergranular glass phase of the Y samples may become soluble in the glass at higher temperatures, leading to a loss of the resistance advantage for Y samples after treatment.

### Example 3

An untreated X sample was subjected to an electric field of 3 V/cm or 6 V/cm at 1200° C. for 1 week. After cooling to room temperature, the sample was machined into bars (3×5×16.5 mm). A three-point bending creep test was performed on the treated sample as well as untreated X and T samples at 1180° C. under 1000 psi of pressure and subsequently at 1250° C. under 1000 psi of pressure. The results of the analysis are summarized in Table II below.

TABLE II
Creep Rate of X Samples

| | Creep Rate (h⁻¹) | Creep Rate (h⁻¹) |
|---|---|---|
| Sample | (1180° C.) | (1250° C.) |
| Untreated X | 2.87 × 10⁻⁵ | Failed |
| X-12: 3 V, 1200° C., 1 wk | 1.53 × 10⁻⁶ | 4.48 × 10⁻⁶ |
| X-13: 3 V, 1200° C., 1 wk | 8.03 × 10⁻⁷ | 2.34 × 10⁻⁵ |
| X-14: 6 V, 1200° C., 1 wk | 8.12 × 10⁻⁷ | 2.36 × 10⁻⁵ |
| X-15: 3 V, 1200° C., 1 wk | 1.58 × 10⁻⁶ | 4.99 × 10⁻⁶ |
| Untreated Y | 5.27 × 10⁻⁷ | 4.57 × 10⁻⁶ |

It was observed that the treated X samples each had significantly lower creep rates as compared to the untreated X sample at both temperatures. At 1180° C., the creep rates for the treated samples are lower by a factor of at least 10. At 1250° C., the untreated sample failed the creep test, whereas the treated samples survived the test and showed a creep rate similar to or better than that of the untreated X sample at the lower measured temperature. The average creep rate for treated X samples was 1.18×10⁻⁶ h⁻¹ at 1180° C. and 1.41×10⁻⁵ h⁻¹ at 1250° C. As compared to the untreated Y sample, the average treated X sample creep rate was approximately twice as high for both temperatures, although certain samples (X-13, X-14) had creep rates similar to that of untreated Y. As compared to the untreated X sample, the average treated X sample creep rate was about 24 times lower for measurements made at 1180° C. (untreated X failed at 1250° C.).

It was also observed that the electric resistance of sample X-14 was the highest (36,000 ohm at 1200° C.), followed by sample X-13 (4,700 ohm at 1200° C.), whereas samples X-12 and X-15 had the lowest resistance. Samples X-13 and X-14 were machined before analysis to remove the electrodes and the enriched cathode region was polished off. In contrast, samples X-12 and X-15 were ground down, but were polished from the anode side to their final dimension. As such, it is believed that samples X-12 and X-15 preserved higher mobile cation concentrations, resulting in lower resistance and higher creep rates. It is also believed that samples X-13 and X-14 had lower mobile cation concentrations, resulting in higher resistance and lower creep rates similar to that of untreated zircon Y.

### Example 4

An untreated Y sample was subjected to an electric field of 5 V/cm at 1320° C. for 50 hours. After cooling to room temperature, the electrodes were removed, as well as a 0.5 mm band on the cathode side, and the sample was machined into bars (5×5.5×16.5 mm). A 3-point bending creep test was performed on the treated sample as well as an untreated Y samples (two lots, a-b) at 1294° C. under 625 psi of pressure. The results of the analysis are summarized in Table III below.

TABLE III
Creep Rate of Y Samples

| | Creep Rate (h⁻¹) |
|---|---|
| Sample | (1294° C.) |
| Y-a1 | 4.84 × 10⁻⁶ |
| Y-a2 | 4.00 × 10⁻⁶ |
| Y-a3 | 3.92 × 10⁻⁶ |
| Y-b1 | 5.54 × 10⁻⁶ |
| Untreated Y-a | 9.89 × 10⁻⁶ |
| Untreated Y-b | 8.33 × 10⁻⁶ |
| (12 run average) | |

It was observed that the treated Y samples each had significantly lower creep rates as compared to both untreated Y samples. At 1300° C., the creep rates for the treated samples are lower by a factor of 2 or 2.5. The average creep rate for untreated Y samples (14 runs total) was 8.2×10⁻⁶ h⁻¹ at 1294° C. In contrast, the average creep rate for treated Y samples was 4.2×10⁻⁶ h⁻¹ at 1294° C. (nearly two times lower).

### Example 5

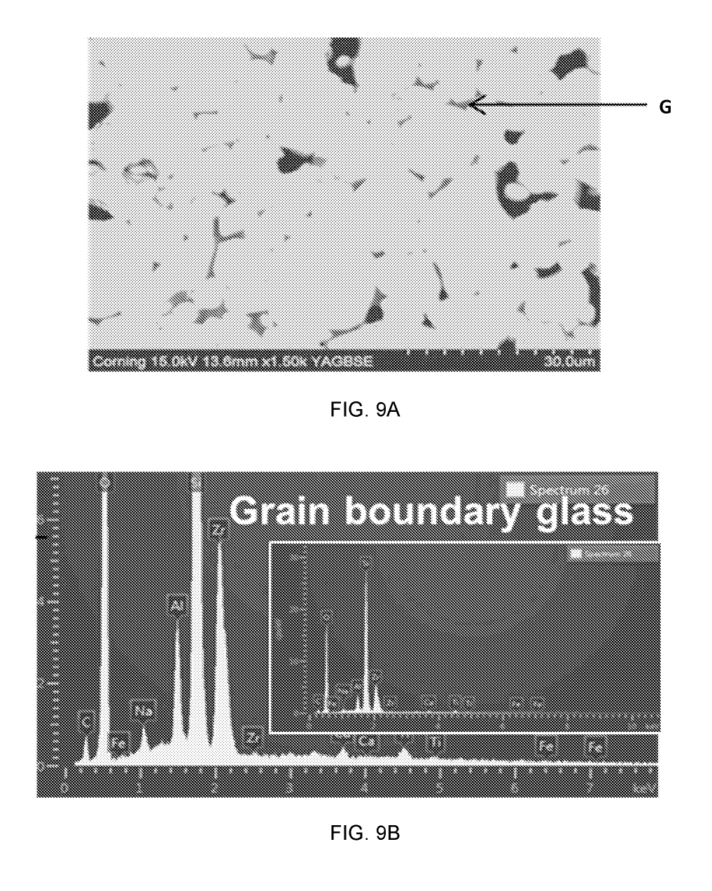

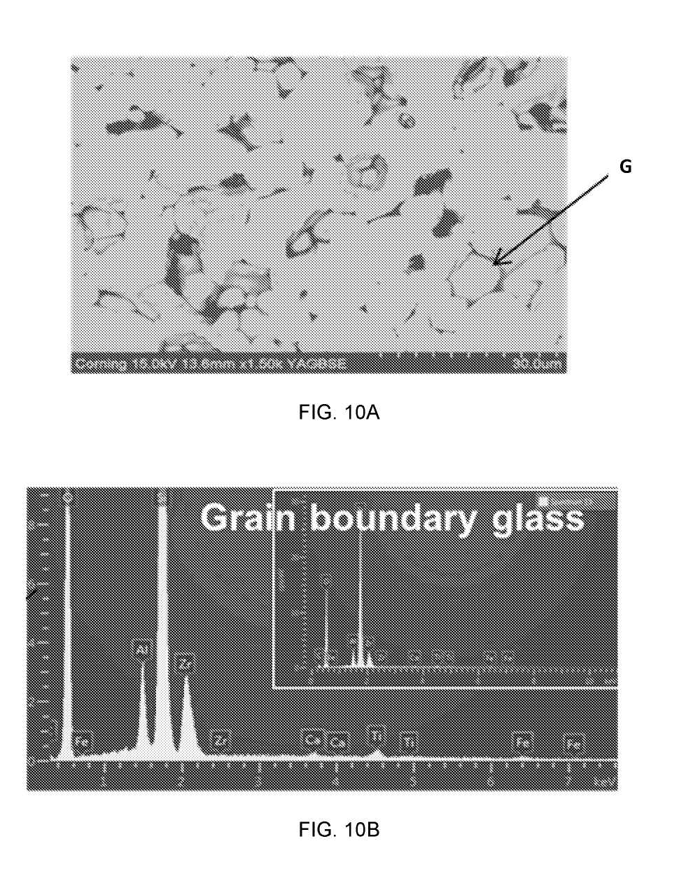

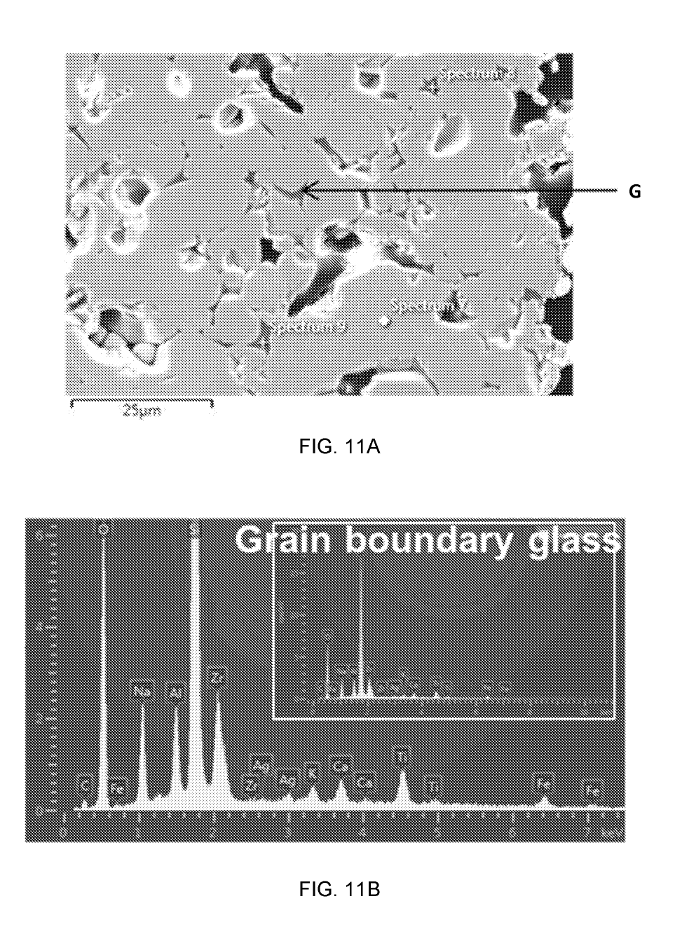

Treated X samples from Example 1 were cut into anode and cathode samples and analyzed by scanning electron microscopy (SEM) and energy dispersive X-ray spectroscopy (EDS). FIGS. 9A-B are an SEM image of an untreated X sample and the corresponding EDS spectrum of the glass pocket G, respectively. Similarly, FIGS. 10A-B are an SEM image and EDS spectrum of a treated X anode sample and FIGS. 11A-B are an SEM image and EDS spectrum of a treated X cathode sample. In the EDS spectra, the enlarged inlet shows the total spectrum scaled to the highest intensity peak, while the low intensity impurity peaks can be better observed in the larger spectrum.

Referring to FIG. 9A, it was observed that the untreated X sample has a ceramic phase comprising crystal grains and a glass phase between the grains, including extended triple point glass pockets. Comparing FIG. 9A to FIGS. 10A and 11A, it was observed that the general microstructure of the X sample did not change with treatment, despite changes in the composition of the glass phase. It was determined that the glass phase made up approximately 3% of the treated and untreated X samples, and that all samples had a porosity of about 5-7%.

Referring to FIG. 9B, the EDS spectrum of the untreated X sample demonstrates Al, Na, Ca, Ti, and Fe peaks, which represent impurities in the glass phase. After treatment, only Al, Si, and Zr remain in the anode sample (FIG. 10B). The peaks corresponding to the other cations were reduced to an almost negligible level. FIG. 10B indicates that a viscous silica glass with low amounts of alumina was present at the anode side of the sample, this glass having a low mobility for ion transport, including the ceramic matrix ions (e.g., Zr, Si, O). FIG. 11B illustrates high levels of impurity cations Na, Al, Ti, Ca, Fe, and Ag. The EDS spectra thus show that the anode sample was successfully treated to remove mobile cations, and that these mobile cations migrated toward the cathode during the electric field treatment, where they enriched in glass pockets in the cathode sample.

### Example 6

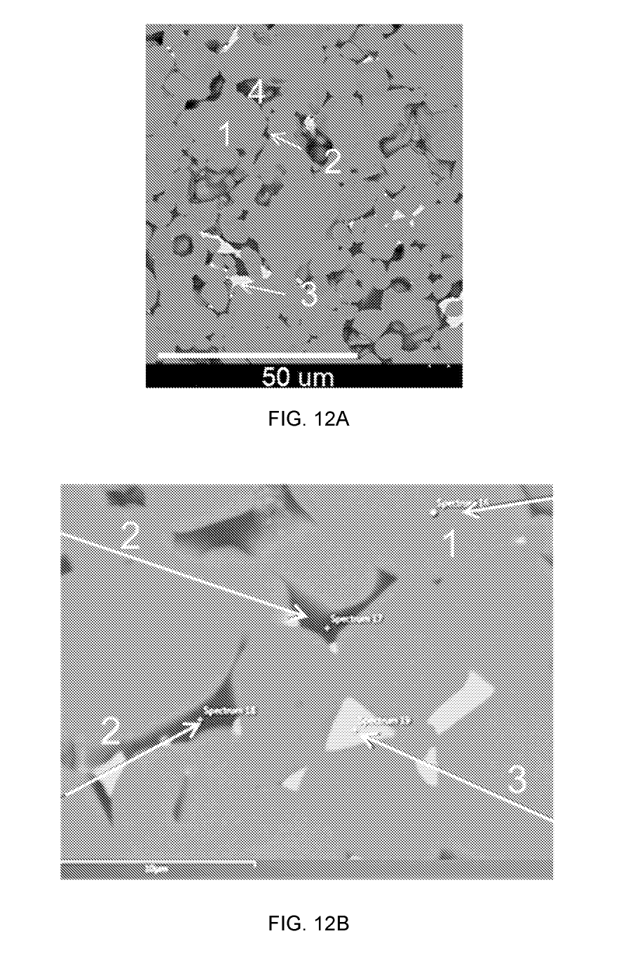

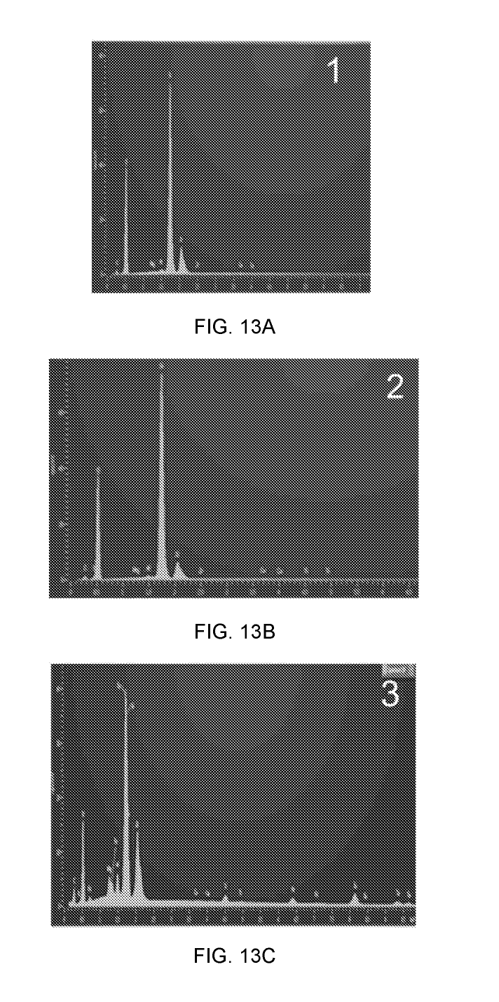

Treated Y samples from Example 1 were cut into anode and cathode samples and analyzed by SEM and EDS. FIGS. 12A-B are SEM images of the general microstructure of an untreated Y sample with magnification to 50 μm and 10 μm, respectively. Region (1) corresponds to a zircon grain, region (2) corresponds to a glass pocket, region (3) corresponds to a tantalate precipitate, and region (4) corresponds to porosity in the sample. FIGS. 13A-C are corresponding EDS spectra for regions (1)-(3). FIG. 13A, corresponding to a zircon grain, does not reveal any major constituents other than Zr, Si, and O. As illustrated in FIG. 13B, the glass pocket region contains Si as a major component and small amounts of Na, Mg, Al, K, Ca, Ti, and Fe impurities. FIG. 13C, corresponding to a tantalate precipitate, illustrates major peaks for Ta and O, and smaller peaks for Mg, Al, Ca, Ti, and Fe, as well as an artifact Zr peak from the ceramic matrix. The tantalate precipitate likely comprises a mixed oxide including the impurity ions.

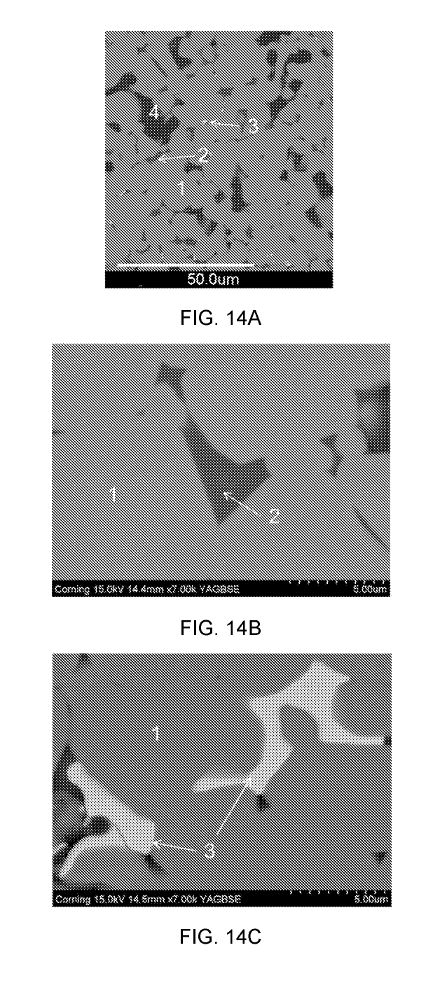

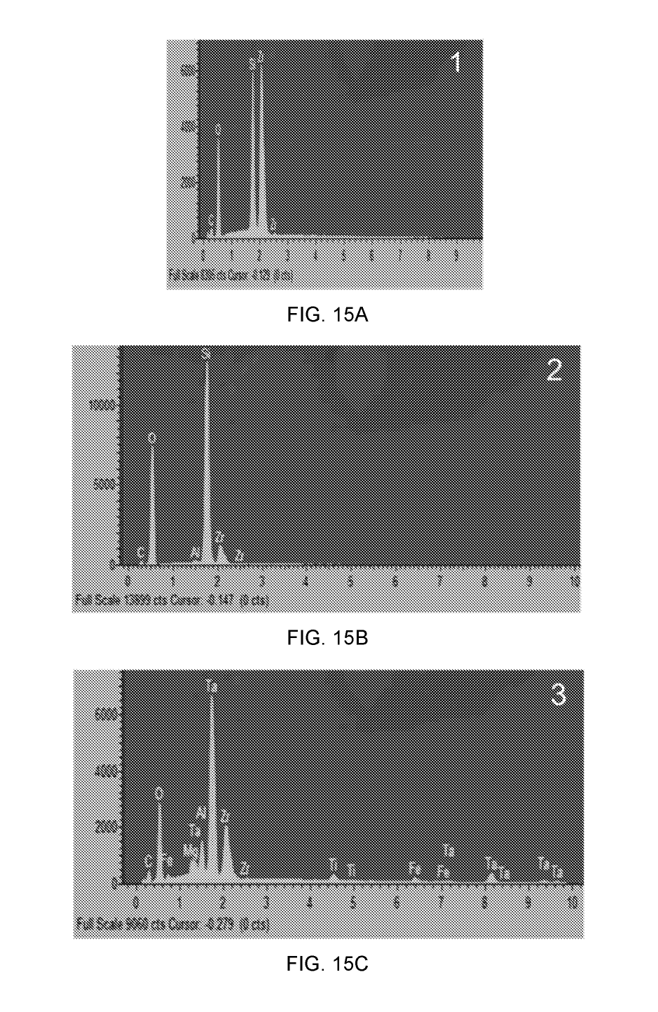

FIGS. 14A-C are SEM images of the general microstructure of a treated Y anode sample with magnification to 50 μm, 5 μm (regions 1 and 2), and 5 μm (regions 1 and 3) respectively. Region (1) corresponds to a zircon grain, region (2) corresponds to a glass pocket, region (3) corresponds to a tantalate precipitate, and region (4) corresponds to porosity in the sample. FIGS. 15A-C are corresponding EDS spectra for regions (1)-(3). FIG. 15A, corresponding to a zircon grain, does not reveal any major constituents other than Zr, Si, and O. As illustrated in FIG. 15B, the glass pocket region contains Si as a major component and small amounts of Zr (possibly an artifact peak from the ceramic matrix) and Al. FIG. 15C, corresponding to a tantalate precipitate, illustrates major peaks for Ta and O, and smaller peaks for Mg, Al, Ti, and Fe, as well as an artifact Zr peak from the ceramic matrix. Ca was not observed in the tantalate precipitate on the anode side. It is believed that the impurity ions in the tantalate precipitate are strongly bonded to tantalum oxide, likely as a mixed oxide. Referring to FIG. 13C, the SEM enlargement of region (3) demonstrates a defined precipitate interface with sharp facets and rounded corners and edges possibly representing of a dissolution morphology. The precipitates, as analyzed by SEM and EDS, appeared to comprise a single, homogenous tantalate phase.

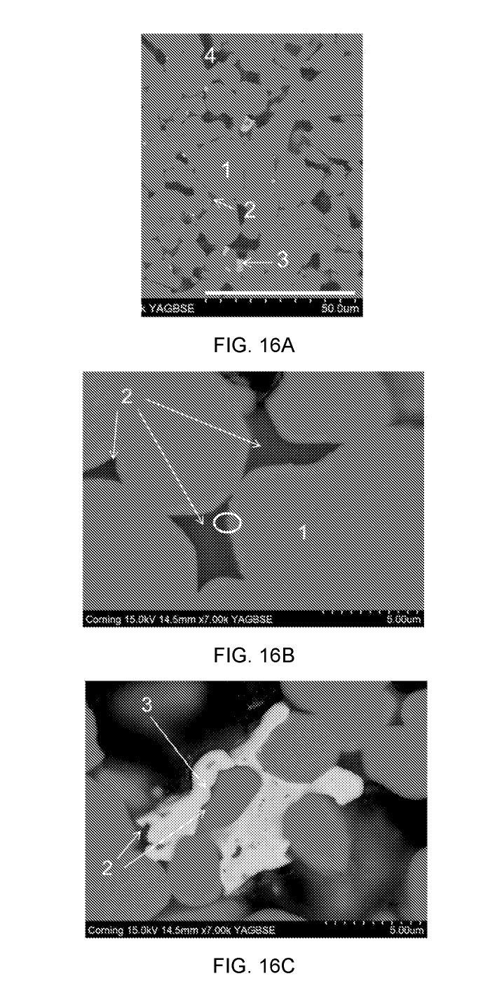

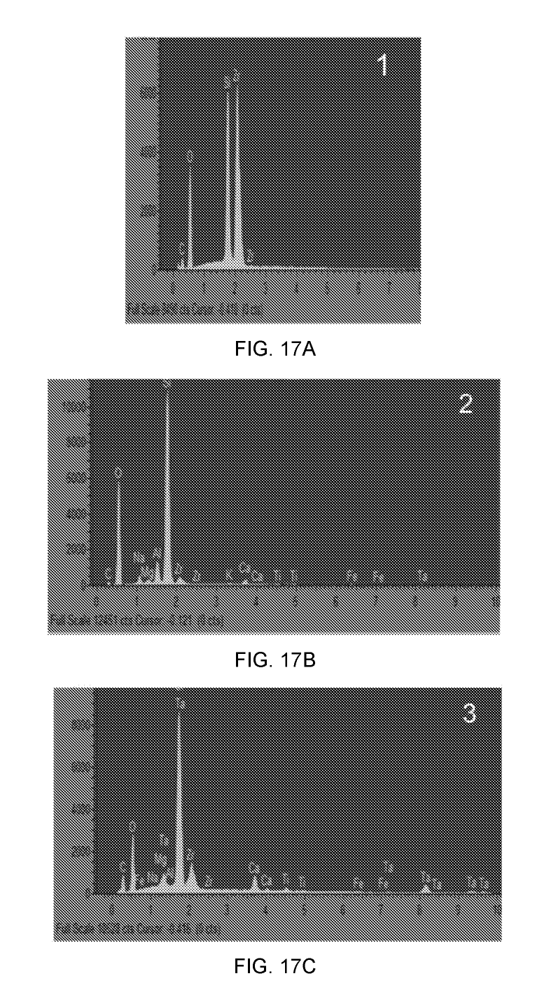

FIGS. 16A-C are SEM images of the general microstructure of a treated Y cathode sample with magnification to 50 μm, 5 μm (regions 1 and 2), and 5 μm (regions 2 and 3) respectively. Region (1) corresponds to a zircon grain, region (2) corresponds to a glass pocket, region (3) corresponds to a tantalate precipitate, and region (4) corresponds to porosity in the sample. FIGS. 17A-C are corresponding EDS spectra for regions (1)-(3). FIG. 17A, corresponding to a zircon grain, does not reveal any major constituents other than Zr, Si, and O. As illustrated in FIG. 17B, the glass pocket region contains Si as a major component and small amounts of Na, Mg, Al, K, Ca, Ti, and Fe impurities, which is indicative of a relatively low viscosity silicate glass. FIG. 16C is an enlargement of a grain boundary interface circled in FIG. 16B, which shows that the interfaces of the glass pockets can include small tantalate precipitates. FIG. 17C, corresponding to a tantalate precipitate, illustrates major peaks for Ta and O, and smaller peaks for Mg, Ti, Fe, and Ca, as well as an artifact Zr peak from the ceramic matrix. In contrast to the anode side, Ca was observed in the tantalate precipitate on the cathode side. It is believed that the impurity ions in the tantalate precipitate are strongly bonded to tantalum oxide, likely as a mixed oxide. Referring again to FIG. 16C, the SEM enlargement of region (3) demonstrates irregular interfaces between the precipitate and the glass (as compared to the defined interfaces at the anode). The observed wavy interface may be representative of a growth-type morphology (as compared to the dissolution morphology at the anode). As such, for longer processing times and/or higher temperatures and/or voltage, it may be possible to dissolve the tantalate such that the remainder of cations in the precipitate can also migrate to the cathode. The precipitates also contain several small inclusions of different compositions (as compared to the homogenous precipitates at the anode), suggesting that the inclusions, as well as the precipitates themselves, may have formed by cooling of a supersaturated tantalate.

Referring in general to FIGS. 12-17, the glass phase of treated Y material is depleted of mobile cations at the anode side, whereas the cathode side is enriched with these mobile cations. A thin band of mobile cations was visible as a white band on the sample cross-section. This enriched layer may, in some cases, be less than 100 μm thick, such as less than 50 μm thick, or even less than 30 μm thick. Furthermore, the tantalate precipitates can be separated into two distinct phases at the anode (Mg—Al—Zr-tantalate) and cathode (Ca-tantalate), with the latter possibly being formed during cooling once sufficient calcium is enriched in the cathode region.

### Example 7

Treated Y-5 and Y-8 cathode and anode samples were prepared as described in Example 2 and analyzed by inductively coupled plasma mass spectroscopy (ICP). The anode sample was 5 mm thick and the cathode sample was 3 mm thick. A 1 mm fragment of a visibly enriched band of the cathode sample was also analyzed (the enriched layer itself was determined to be about 50 μm thick). The results of the analysis for Y-5 and Y-8 are presented in Tables IV and V, respectively, with values expressed in ppm unless clearly indicated otherwise.

TABLE IV
ICP Analysis of Y-5 Samples

| | | | |
|---|---|---|---|
| | Y-5 anode | Y-5 cathode | Untreated Y |
| Element | μg/g (ppm) | μg/g (ppm) | μg/g (ppm) |

| Ag | 65 | | 58 | | 59 | |
|---|---|---|---|---|---|---|
| Al | 0.45 | wt % | 0.43 | wt % | 0.46 | wt % |
| As | <0.4 | | <0.4 | | <0.4 | |
| Au | <2 | | <2 | | <2 | |
| Ba | 6 | | 6 | | 6 | |
| Be | 0.3 | | 0.2 | | 0.2 | |
| Bi | <0.1 | | <0.1 | | <0.1 | |
| Ca | 83 | | 120 | | 85 | |
| Cd | 10 | | 8 | | 12 | |
| Ce | 4 | | 8 | | 8 | |
| Co | 0.05 | | 0.06 | | <0.05 | |
| Cr | 2 | | 2 | | 2 | |
| Cs | <0.01 | | 0.06 | | 0.03 | |
| Cu | <0.4 | | 1.2 | | 1.0 | |
| Dy | 8 | | 12 | | 15 | |
| Er | 11 | | 21 | | 26 | |
| Eu | 0.3 | | 0.3 | | 0.6 | |
| Fe | 360 | | 350 | | 320 | |
| Ga | 0.2 | | 0.3 | | 0.4 | |
| Gd | 0.4 | | 0.7 | | 0.8 | |
| Ge | 0.3 | | 0.3 | | 0.3 | |
| Hg | NQ | | NQ | | NQ | |
| Hf | 1.50 | wt % | 1.52 | wt % | 1.51 | wt % |

| | | | |
|---|---|---|---|
| Ho | 2 | 5 | 5 |
| Ir | <0.05 | <0.05 | <0.05 |
| K | 14.1 | 110 | 38 |
| La | <0.6 | 1 | 2 |
| Li | 0.2 | 2 | 5 |
| Lu | 3.6 | 6.8 | 7.6 |
| Mg | 180 | 170 | 150 |
| Mn | 3 | 3 | 3 |
| Mo | <0.05 | <0.05 | 0.08 |
| Na | 5 | 400 | 130 |
| Nb | 5 | 5 | 5 |
| Nd | 2 | 3 | 3 |
| Ni | 2 | 2 | 0 |
| Os | NQ | NQ | NQ |

| | | | | | |
|---|---|---|---|---|---|
| P | 0.37 wt % | 0.87 | wt % | 0.38 | wt % |

| Pb | 4 | | 5 | | 7 | |
|---|---|---|---|---|---|---|
| Pd | 17 | | 34 | | 33 | |
| Pr | 0.4 | | 0.6 | | 0.7 | |
| Pt | 1 | | 7 | | 8 | |
| Rb | 0.02 | | 0.9 | | 0.3 | |
| Re | <0.01 | | 0.02 | | 0.02 | |
| Rh | <0.01 | | <0.01 | | <0.01 | |
| Ru | <0.01 | | <0.01 | | <0.01 | |
| Sb | 0.7 | | <0.2 | | <0.2 | |
| Se | <0.01 | | <0.01 | | <0.01 | |
| Sm | 2 | | 2 | | 3 | |
| Sn | 0.9 | | 0.7 | | 0.6 | |
| Sr | 11 | | 7 | | 6 | |
| Ta | 0.92 | wt % | 0.94 | wt % | 0.93 | wt % |
| Tb | 0.6 | | 1 | | 1 | |
| Te | <50 | | <50 | | <50 | |
| Th | 9 | | 11 | | 18 | |
| Ti | 0.042 | wt % | 0.043 | wt % | 0.044 | wt % |
| Tl | <0.2 | | <0.2 | | <0.2 | |
| Tm | 2.4 | | 4.3 | | 5.0 | |
| U | 150 | | 120 | | 160 | |
| V | 2 | | 2 | | 2 | |
| W | 0.4 | | 0.4 | | 0.4 | |
| Y | 0.066 | wt % | 0.065 | wt % | 0.062 | wt % |

| | | | |
|---|---|---|---|
| Yb | 18 | 48 | 52 |
| Zn | 9 | 8 | 9 |

TABLE V
ICP Analysis of Y-8 Samples

| | | | |
|---|---|---|---|
| | Y-8 anode | Y-8 cathode | Untreated Y |
| Element | μg/g (ppm) | μg/g (ppm) | μg/g (ppm) |

| Ag | <3 | | | | 59 | |
|---|---|---|---|---|---|---|
| Al | 0.37 | wt % | 0.15 | wt % | 0.46 | wt % |
| As | | | | | <0.4 | |
| Au | <0.1 | | | | <2 | |
| Ba | 5 | | 300 | | 6 | |
| Be | 0.43 | | | | 0.2 | |
| Bi | 0 | | | | <0.1 | |
| Ca | 55.21 | | 240 | | 85 | |
| Cd | <1 | | | | 12 | |
| Ce | 2 | | | | 8 | |
| Co | <0.1 | | | | <0.05 | |
| Cr | 2 | | | | 2 | |
| Cs | <0.05 | | | | 0.03 | |
| Cu | <0.1 | | | | 1.0 | |
| Dy | 3.80 | | | | 15 | |
| Er | 6.01 | | | | 26 | |
| Eu | 0 | | | | 0.6 | |
| Fe | 390 | | 280 | | 320 | |
| Ga | 0.4 | | | | 0.4 | |
| Gd | 0.9 | | | | 0.8 | |
| Ge | 0.2 | | | | 0.3 | |
| Hg | NQ | | | | NQ | |
| Hf | 1.52 | wt % | 0.88 | wt % | 1.51 | wt % |
| Ho | 1.4 | | | | 5 | |
| Ir | <0.4 | | | | <0.05 | |
| K | <0.6 | | 30 | | 38 | |
| La | 0.6 | | | | 2 | |
| Li | <0.1 | | 1 | | 5 | |
| Lu | 2.6 | | | | 7.6 | |
| Mg | 200 | | 160 | | 150 | |
| Mn | 2.8 | | | | 3 | |
| Mo | <0.1 | | | | 0.08 | |
| Na | <4 | | 37 | | 130 | |
| Nb | 4.6 | | | | 5 | |
| Nd | 0.8 | | | | 3 | |
| Ni | <0.1 | | | | 0 | |
| Os | NQ | | | | NQ | |
| P | 0.37 | wt % | 0.1 | wt % | 0.38 | wt % |
| Pb | 4.1 | | | | 7 | |
| Pd | 1.9 | | | | 33 | |
| Pr | 0.2 | | | | 0.7 | |
| Pt | 0.2 | | | | 8 | |
| Rb | 1.1 | | | | 0.3 | |
| Re | <0.01 | | | | 0.02 | |
| Rh | <0.01 | | | | <0.01 | |
| Ru | <0.01 | | | | <0.01 | |
| Sb | <0.1 | | | | <0.2 | |
| Se | <0.01 | | | | <0.01 | |
| Sm | <1 | | | | 3 | |
| Sn | 0.6 | | | | 0.6 | |
| Sr | 5.8 | | | | 6 | |
| Ta | 0.93 | wt % | 0.63 | wt % | 0.93 | wt % |
| Tb | 0.2 | | | | 1 | |
| Te | <4 | | | | <50 | |
| Th | 3.7 | | | | 18 | |
| Ti | 0.043 | wt % | 0.033 | wt % | 0.044 | wt % |
| Tl | <0.01 | | | | <0.2 | |
| Tm | 1.3 | | | | 5.0 | |
| U | 150 | | 130 | | 160 | |
| V | 2.3 | | | | 2 | |
| W | 0.4 | | | | 0.4 | |
| Y | 0.065 | wt % | 0.05 | wt % | 0.062 | wt % |

| Yb | 11.2 | 140 | 52 |
|---|---|---|---|
| Zn | 8.3 | | 9 |

As illustrated in Tables IV and V, electric field treatment of Y removed 89% and 97% of alkali ions, respectively. The total alkali content was reduced to below 20 ppm (Y-5) and even below 5 ppm (Y-8). Sodium content was reduced to below 5 ppm, lithium content below 1 ppm, and potassium content below 15 ppm for both samples.

While some effect was perceived for alkaline earth and transition metals, the overall effect was not as noticeable as that of the alkali ions. Again, it is believed that these elements may be present not only in the glass phase, but also bonded in the tantalate crystalline phase as a relatively stable mixed oxide. Y-5 and Y-8 samples were treated for 20 hours and 50 hours, respectively. Thus, it is believed that the elements bonded to tantalate may not migrate in the initial treatment period, but can migrate with longer treatment times as the tantalate precipitate decomposes and dissolves.

### Example 8

Treated X-6 anode samples were prepared as described in Example 2 and analyzed by ICP. The results of the analysis are presented in Table VI, with values expressed in ppm unless clearly indicated otherwise.

TABLE VI
ICP Analysis of X-6 Samples

| | X-6 anode | Untreated X |
|---|---|---|
| Element | μg/g (ppm) | μg/g (ppm) |
| Ag | <5 | |
| Al | 0.24 wt % | 0.37 wt % |
| As | <1 | |
| Au | 3 | |
| Ba | 20 | |
| Be | 1 | |
| Bi | <0.5 | |
| Ca | 6 | |
| Cd | <0.2 | |
| Ce | 7 | |
| Co | <0.5 | |
| Cr | 3 | |
| Cs | <0.5 | |
| Cu | <0.5 | |
| Dy | 20 | |
| Er | 22 | |
| Eu | <1 | |
| Fe | 450 | 0.07 wt % |
| Ga | <0.5 | |
| Gd | <1 | |
| Ge | 1 | |
| Hg | NQ | |
| Hf | 1.58 wt % | 1.47 wt % |
| Ho | 6 | |
| Ir | <5 | |
| K | 0.5 | |
| La | 2 | |
| Li | <0.5 | |
| Lu | 10 | |
| Mg | 33 | |
| Mn | 6 | |
| Mo | <0.5 | |
| Na | 2 | |
| Nb | 6 | |
| Nd | 3 | |
| Ni | 0.4 | |
| Os | NQ | |
| P | 0.41 wt % | |
| Pb | 6 | |
| Pd | 4 | |
| Pr | <1 | |
| Pt | <1 | |
| Rb | <0.2 | |
| Re | <0.2 | |
| Rh | <0.2 | |
| Ru | <0.2 | |
| Sb | <0.5 | |
| Se | <1 | |
| Sm | 3 | |
| Sn | 4 | |
| Sr | 2 | |
| Ta | <0.005 | |
| Tb | 1 | |
| Te | <1 | |
| Th | 27 | |
| Ti | 0.28 wt % | 0.31 wt % |
| Tl | <0.5 | |
| Tm | 6 | |
| U | 280 | |
| V | 7 | |
| W | <1 | |
| Y | 0.13 wt % | |
| Yb | 43 | |
| Zn | 6 | |

Electric field treatment of zircon X reduced the total alkali content to below 3 ppm, with a sodium content of 2 ppm, a lithium content below 0.5 ppm, and potassium content of 0.5 ppm. It is believed that alkaline earth and transition metal ions may be more mobile in zircon X, which does not comprise tantalate precipitates. As such, the alkaline earth content for electric field treated zircon X was reduced to below 40 ppm, with a calcium content of 6 ppm and a magnesium content of 33 ppm. Iron, titanium, and aluminum content were also noticeably reduced.

### Example 9

Untreated X and Y samples (different from those used in Examples 1-8 above) were machined into bars of varying sizes (X-101/Y-101: 1×1×0.2 cm; X-102/Y-102: 0.3×0.3×15 cm) and placed in a 3″ diameter silica muffle tube furnace and heated to a treatment temperature of 1200° C. for 8 hours in the presence of a N₂/Cl₂ gas mixture (95/5 by volume) flowing at about 1 SLPM. Prior to treatment, the X sample was orange in color and the Y sample was tan in color. After treatment, both samples were white in color. A yellow-orange gas evolved from the furnace and was deposited on the furnace exit tube into a yellowish powder comprising iron chloride and alkali chlorides. After cooling to 25° C., the zircon samples were analyzed by ICP for trace metals. Samples labeled X and Y were machined from larger blocks of Atlas and LCZ zircon from Saint-Gobain (Courbevoie, France), respectively.

Elemental analysis is presented in Table VII. Creep rates for the samples at 125° C. and 1000 psi are presented in Table VIII.

TABLE VII
ICP Analysis of X and Y Samples

| | Untreated X | X-101 | Untreated Y | Y-101 |
|---|---|---|---|---|
| Element | μg/g (ppm) | μg/g (ppm) | μg/g (ppm) | μg/g (ppm) |
| Cr | 2 | 2 | 2 | 0.4 |
| Li | 6.55 | <0.01 | 10 | <0.01 |
| Na | 870 | 30 | 170 | 11 |
| K | 48 | 0.3 | 44 | <0.01 |
| Fe | 390 | 37 | 360 | 56 |
| Ni | <0.01 | <0.01 | <0.01 | <0.01 |
| Ti | 2400 | 1900 | 350 | 230 |
| Mg | 210 | 58 | 220 | 38 |
| Ca | 150 | 130 | 220 | <2 |
| Ta | 2 | 96 | 8100 | 4200 |
| % alkali | | 97% | | 95% |
| removed | | | | |
| % alkaline | | 48% | | 91% |
| earth removed | | | | |
| % iron | | 91% | | 85% |
| removed | | | | |

TABLE VIII
Creep Rate of X and Y Samples

| | Creep Rate (h⁻¹) | Improvement |
|---|---|---|
| Sample | (1250° C.) | (over control) |
| Untreated X | 3.5 × 10⁻⁵ | |
| (control) | | |
| X-102 | 2.5 × 10⁻⁶ | 93% |
| Untreated Y | 2.0 × 10⁻⁶ | |
| (control) | | |
| Y-102 | 1.6 × 10⁻⁶ | 20% |

As illustrated in Table VII, chlorine treatment of zircon X removed greater than 95% of alkali, nearly 50% of alkaline earth, and greater than 90% of iron. For zircon Y, the chlorine treatment removed 95% of alkali, greater than 90% of alkaline earth, and 85% of iron. Additionally, even though half of the tantalum ions were removed from the Y sample, the creep rate of the treated Y sample was still lower than that of the untreated sample, which may indicate that the presence of tantalate precipitates in zircon Y is not critical to attaining the low creep values. The slight increase in Ta in treated sample X-101, indicates that there may have been some cross contamination of the X sample from the Y sample, which were placed in the furnace together. Samples X-102 and Y-102 were subsequently run separately from each other. Referring to Table VIII, a significant decrease (93%) in creep rate was achieved for X samples as well as a decrease (20%) in the already low creep rate for Y samples.

In a separate series of experiments, additional samples labeled Y were machined from larger blocks of LCZ zircon from Saint-Gobain (Courbevoie, France) into 4″ long by 3 mm high by 8 mm wide bars having chamfered edges. Three samples each of material Y were treated with chlorine at 1200° C. for 8 hours as described above. Samples of untreated (labeled Y-as-is) as well as the chlorine treated samples labeled (Y—Cl) were tested for static fatigue time to failure (breakage of the bar); the conditions were 4-point bending, 20 mm (center-to-center) upper span and 64 mm (center-to-center) lower span with a pressure of 4000 psi (27.6 MPa) at 1250° C. The three untreated Y-as-is samples broke after only about 1.6 hours on average (one each at 1.13, 1.43 and 2.32 hours). The three chlorine treated Y—Cl samples had significantly higher fatigue life and broke after about 26 hours on average (one each at 12.7, 18.8 and 47.7 hours). Thus, these additional experiments exhibited a surprising discovery in that utilizing a halogen treatment (e.g., chlorine, or the like) on refractory materials such as zircon can greatly improve static fatigue life. It follows that other static fatigue pressures (100 to 8000 psi) and temperatures (800-1500° C.) could be expected to also show the benefit of chlorine treating zircon for improved lifetimes and lower creep rates. Other ceramic materials described herein are expected to be improved in static fatigue by similar halogen treatment.

In additional experiments, fused zirconia refractory (e.g., glass-bonded polycrystalline zirconia powder, electrocast zirconia (Scimos CZ and Xilec 9 from Saint-Gobain (Courbevoie, France)), and the like) was used in glass melting operations and was characterized for electrical resistivity properties at elevated temperatures. Samples from these materials were used for testing and were labeled “SC-FZ, as-received” and “XI-FZ, as received”, respectively. In addition, samples of the as-received fused zirconia were also placed in a 3″ diameter silica muffle tube furnace and heated to a treatment temperature of 1200° C. for 8 hours and then 1350° C. for an additional 8 hours in the presence of a N₂/Cl₂ gas mixture (95/5 by volume) flowing at about 2 SLPM. These samples were testing and labeled as “SC-FZ.CI, inventive” and “XI-FZ.CI, inventive”, respectively. Prior to chlorine treatment, the SC-FZ, as-received sample was tan in color and the XI-FZ, as received sample was dark tan/grey in color. After treatment, both samples were observed to be lighter in color. A yellow-orange gas evolved from the furnace and was deposited on the furnace exit tube into a yellowish powder comprising iron chloride and alkali chlorides. After cooling to 25° C., the fused zirconia samples were analyzed by ICP for trace metals the results of which are shown below in Table IX.

TABLE IX
ICP Analysis of fused zirconia Samples

| | Untreated | Cl2 treated | Untreated | Cl2 treated |
|---|---|---|---|---|
| | Scimos CZ | Scimos CZ | Xilec 9 | Xilec 9 |
| | (SC-FZ, | (SC-FZ.Cl, | (XI-FZ, | (XI-FZ.Cl, |
| | as-received) | invenitve) | as-received) | invenitve) |
| Element | μg/g (ppm) | μg/g (ppm) | μg/g (ppm) | μg/g (ppm) |
| Cr | 7 | 3 | 6 | 5 |
| Li | <1 | <1 | <1 | <1 |
| Na | 63 | 3 | 29 | 2 |
| K | 320 | 41 | 2 | <1 |
| Fe | 350 | 110 | 520 | 380 |
| Ni | <1 | <1 | <1 | <1 |
| Ti | 1300 | 650 | 1100 | 710 |
| Mg | 14 | 12 | 26 | 25 |
| Ca | 460 | 140 | 11300 | 8300 |
| Ta | <1 | <1 | 8100 | 4200 |
| % total | | 86% | | 94% |
| alkali | | | | |
| removed | | | | |
| % iron | | 69% | | 27% |
| removed | | | | |

With reference to Table IX above, it can be observed that exemplary chlorine treating methods described herein as applied to Scimos CZ and Xilec 9 fused zirconia removed greater than 85% and 90% of alkali contaminants, respectively, and greater than 65% and 25% of iron contaminants, respectively.

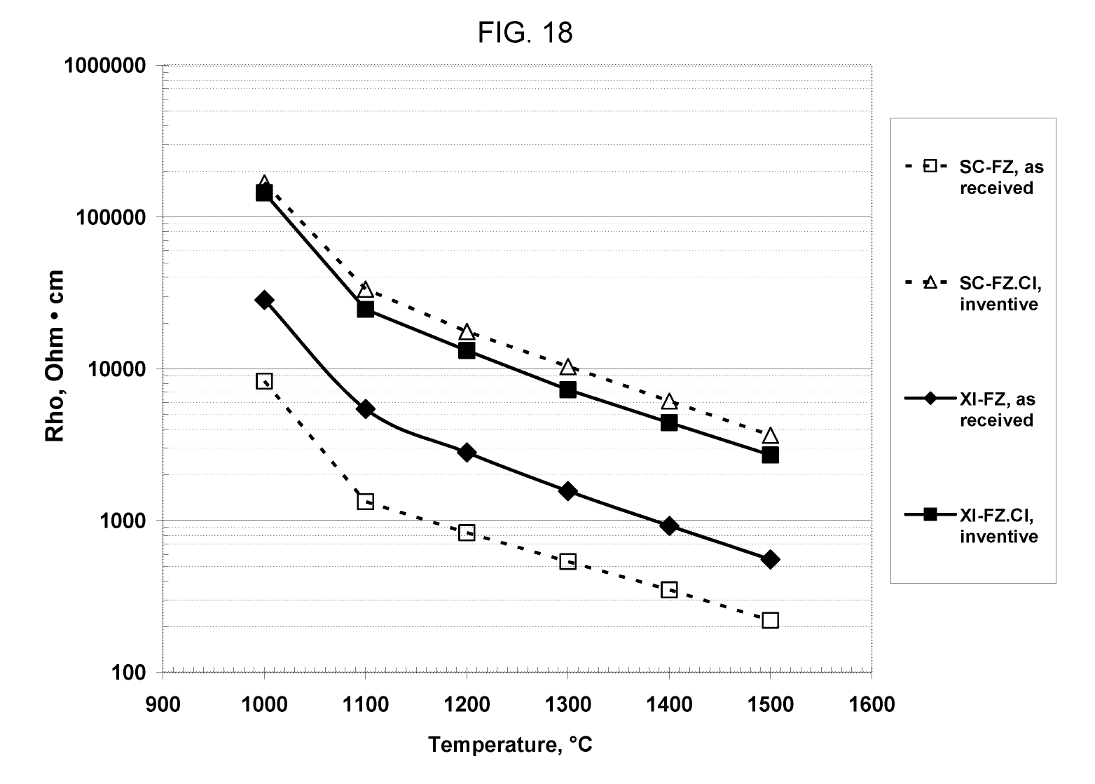

In additional experiments, it was determined that the chlorine treated fused zirconia refractory provided superior resistivity which allows higher power for electric melting of glass while avoiding an issue of fire-through generally encountered with existing ceramic refractory materials. In these experiments, portions of fused zirconia described above (e.g., Table IX) were made into 1.98 cm (diameter)×1.51 cm (length) samples for high temperature electrical resistivity characterization using Pt disc electrodes in contact with the sample ends (diameter). The samples were placed in a temperature controlled furnace and monitored at 60 Hz frequency for electrical resistivity as a function of temperature (from 1000° C. to 1500° C.). With reference to FIG. 18, it can be observed that samples of chlorine treated fused zirconia exhibited excellent resistivity and significantly higher than the as-received fused zirconia samples. For example, the as received Scimos CZ samples exhibited resistivities of 8292 Ohm*cm (1000° C.), 1333 Ohm*cm (1100° C.), 832 Ohm*cm (1200° C.), 535 Ohm*cm (1300° C.), 350 Ohm*cm (1400° C.) and 220 Ohm*cm (1500° C.), whereas the chlorine treated Scimos CZ fused zirconia samples increased in resistivity on the order of 16+ times, even at the highest temperature tested to resistivities of 168000 Ohm*cm (1000° C.), 33500 Ohm*cm (1100° C.), 17580 Ohm*cm (1200° C.), 10350 Ohm*cm (1300° C.), 6130 Ohm*cm (1400° C.) and 3643 Ohm*cm (1500° C.). By way of further example, the as received Xilec 9 samples exhibited resistivities of 28450 Ohm*cm (1000° C.), 5441 Ohm*cm (1100° C.), 2809 Ohm*cm (1200° C.), 1566 Ohm*cm (1300° C.), 922 Ohm*cm (1400° C.) and 555 Ohm*cm (1500° C.), whereas the chlorine treated Xilec 9 fused zirconia samples increased in resistivity on the order of 4.8+ times, even at the highest temperature tested to resistivities of 144200 Ohm*cm (1000° C.), 24610 Ohm*cm (1100° C.), 13180 Ohm*cm (1200° C.), 7270 Ohm*cm (1300° C.), 4410 Ohm*cm (1400° C.) and 2700 Ohm*cm (1500° C.). Without being bound by theory, it is believed that the low alkali impurities (total Li, Na, K) remaining in the fused zirconia samples after the chlorine treatment step is at least partially the reason for excellent resistivity of the fused zirconia.

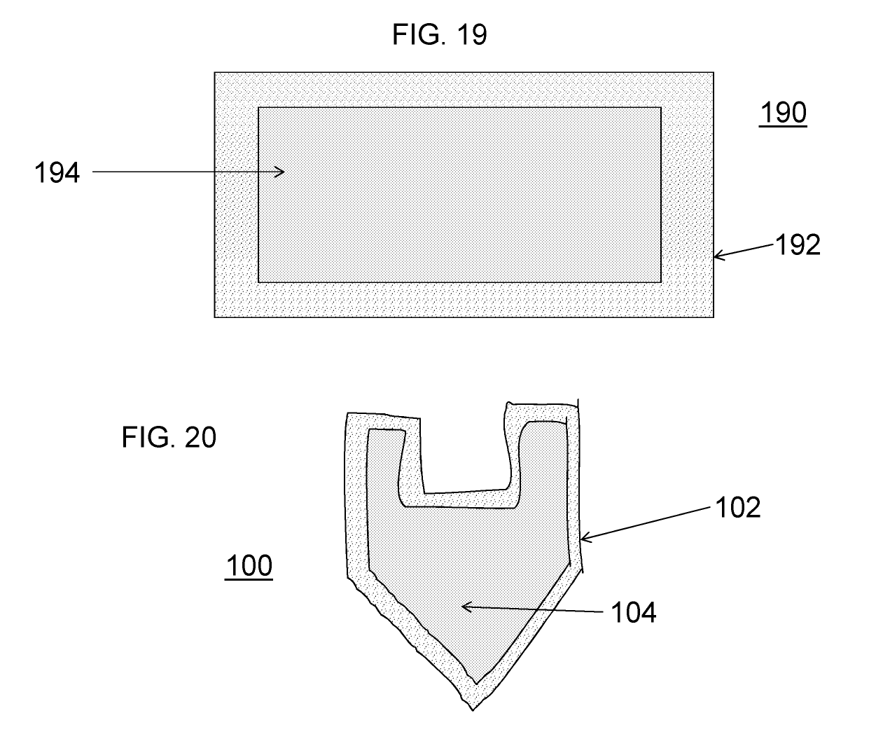

FIG. 19 is a depiction of a refractory article (refractory brick) with all or a portion thereof exposed to exemplary treatment methods. FIG. 20 is a depiction of another refractory article (forming body or isopipe) with all or a portion thereof exposed to exemplary treatment methods. With reference to FIG. 19, a refractory article (e.g., refractory brick) 190 is depicted having an outer portion 192 and an inner portion 194. As discussed above, the refractory article 190 can be treated according to the methods described herein whereby all or an outer portion 192 (as shown in FIG. 19) thereof has a total alkali content of less than or equal to about 100 ppm, less than or equal to about 50 ppm, or less than or equal to about 20 ppm by weight, or an iron content of less than or equal to about 300 ppm by weight. All or an outer portion of the refractory article can, in some embodiments, also comprise a higher resistivity at 1500° C. of ≥800 Ohm·cm, ≥1000 Ohm·cm, ≥2000 Ohm·cm, or ≥3000 Ohm·cm. All or an outer portion of the refractory article can, in some embodiments, also comprise a creep rate of less than about 5×10⁻⁷ h⁻¹ at 1180° C. and 1000 psi, a creep rate of less than about 2×10⁻⁶ h⁻¹ at 1250° C. and 1000 psi, or a creep rate of less than about 8×10⁻⁶ h⁻¹ at 1300° C. and 625 psi. Exemplary refractory articles can include dimensions (length, width, and/or height) ≥2 cm, ≥5 cm, ≥10 cm, ≥100 cm, and any combination thereof. In embodiments where only an outer portion 192 of the refractory article 190 is exposed to exemplary treatment methods, a thickness of such an outer portion 192 can be ≥0.5 cm, ≥1 cm, ≥2 cm, or ≥5 cm. With reference to FIG. 20, another refractory article (e.g., forming body or isopipe as depicted in FIG. 2) 100 is depicted having an outer portion 102 and an inner portion 104. As discussed above, the refractory article 100 can be treated according to the methods described herein whereby all or an outer portion 102 (as shown in FIG. 20) thereof has a total alkali content of less than or equal to about 100 ppm, less than or equal to about 50 ppm, or less than or equal to about 20 ppm by weight, or an iron content of less than or equal to about 300 ppm by weight. All or an outer portion of the refractory article can, in some embodiments, also comprise a higher resistivity at 1500° C. of ≥800 Ohm·cm, ≥1000 Ohm·cm, ≥2000 Ohm·cm, or ≥3000 Ohm·cm. All or an outer portion of the refractory article can, in some embodiments, also comprise a creep rate of less than about 5×10⁻⁷ h⁻¹ at 1180° C. and 1000 psi, a creep rate of less than about 2×10⁻⁶ h⁻¹ at 1250° C. and 1000 psi, or a creep rate of less than about 8×10⁻⁶ h⁻¹ at 1300° C. and 625 psi. Exemplary refractory articles can include dimensions (length, width, and/or height) ≥2 cm, ≥5 cm, ≥10 cm, ≥100 cm, and any combination thereof. In embodiments where only an outer portion 102 of the refractory article 100 is exposed to exemplary treatment methods, a thickness of such an outer portion 102 can be ≥0.5 cm, ≥1 cm, ≥2 cm, or ≥5 cm.

1. A ceramic material comprising:
a ceramic phase;
a glass phase; and
at least one of:
a total alkali content of less than or equal to about 100 ppm by weight in a first portion of the material; or
an iron content of less than or equal to about 300 ppm by weight in the first portion.

2. A ceramic material comprising:
a ceramic phase;
a glass phase; and
at least one of:
a creep rate of less than about 5×10⁻⁷ h⁻¹ at 1180° C. and 1000 psi in a first portion of the material;
a creep rate of less than about 2×10⁻⁶ h⁻¹ at 1250° C. and 1000 psi in the first portion; or
a creep rate of less than about 8×10⁻⁶ h⁻¹ at 1300° C. and 625 psi in the first portion.

3. A ceramic material comprising:
a ceramic phase;
a glass phase; and
at least one of:
a resistivity of greater than or equal to 800 ohm-cm at 1500° C. in a first portion of the material;
a resistivity of greater than or equal to 1000 ohm-cm at 1500° C. in the first portion; or
a resistivity of greater than or equal to 2000 ohm-cm at 1500° C. in the first portion.

4-52. (canceled)

53. A ceramic material according to claim 1, 2 or 3, wherein the total alkali content ranges from about 1 ppm to about 100 ppm by weight.

54. A ceramic material according to claim 1, 2 or 3, comprising at least one of:
less than or equal to about 50 ppm by weight of sodium;
less than or equal to about 20 ppm by weight of lithium; or
less than or equal to about 20 ppm by weight of potassium.

55. A ceramic material according to claim 1, 2 or 3, wherein a weight ratio of silicon to aluminum in the glass phase is at least about 5:1.

56. A ceramic material according to claim 1, 2 or 3, wherein the glass phase comprises a total content of cations other than silicon and aluminum of less than or equal to about 1 wt %.

57. A ceramic material according to claim 1, 2 or 3, wherein the glass phase comprises from about 2 wt % to about 6 wt % of the total weight of the ceramic material.

58. A ceramic material according to claim 1, 2 or 3, wherein the creep rate at 1250° C. and 1000 psi is less than or equal to about 1.5×10⁻⁶ h⁻¹.

59. A ceramic material according to claim 1, 2 or 3, comprising at least one of:
a specific electric resistance of at least about 1×10⁴ ohm·cm at 1180° C.
a specific electric resistance of at least about 5×10³ ohm·cm at 1250° C.; or
a specific electric resistance of at least about 3×10³ ohm-cm at 1300° C.

60. A ceramic material according to claim 1, 2 or 3, wherein the ceramic phase comprises a plurality of grains and the glass phase is an intergranular glass phase.

61. A ceramic material according to claim 1, 2 or 3, wherein the ceramic phase comprises zircon, zirconia, alumina, magnesium oxide, silicon carbide, silicon nitride, silicon oxynitride, xenotime, monazite, mullite, zeolite, alloys thereof, and combinations thereof.

62. A ceramic material according to claim 1, 2 or 3, wherein the ceramic phase comprises zircon or zirconia.

63. A ceramic material according to claim 1, 2 or 3, further comprising at least one secondary crystalline phase, present in an amount of less than about 5% by volume relative to a total volume of the ceramic material.

64. A ceramic material according to claim 1, 2 or 3, further comprising from about 0.001 wt % to about 5 wt % tantalum and/or niobium.

65. A ceramic material according to claim 1, 2 or 3, comprising a porosity of less than about 10%.

66. A ceramic material according to claim 1, 2 or 3, wherein the first portion of the material comprises an outer portion having a thickness of greater than or equal to 0.5 cm, greater than or equal to 1 cm, greater than or equal to 2 cm, or greater than or equal to 5 cm

67. A refractory brick comprising a ceramic material according to claim 1, 2, or 3.

68. A forming body comprising a ceramic material according to claim 1, 2, or 3.

69. A method for treating a ceramic body comprising a ceramic phase and a glass phase, the method comprising:
heating the ceramic body to a treatment temperature;
contacting a surface of the ceramic body with an anode;
contacting an opposing second surface of the ceramic body with a cathode; and
applying an electric field between the anode and cathode to create an electric potential difference across the ceramic body between the anode and cathode.

70. The method according to claim 69, wherein the treatment temperature ranges from about 1000° C. to about 1500° C.

71. The method according to claim 69, wherein the electric potential difference ranges from about 0.1 V/cm to about 20 V/cm.

72. The method according to claim 69, wherein a treatment duration ranges from about 1 hour to about 1000 hours.

73. The method according to claim 69, further comprising removing a portion of the ceramic body adjacent the cathode after applying the electric field to produce a treated ceramic material.

74. The method according to claim 73, wherein the treated ceramic material comprises at least one of an alkali content of less than or equal to about 100 ppm by weight or an iron content of less than or equal to about 300 ppm by weight.

75. A method for treating a ceramic body comprising a ceramic phase and a glass phase comprising at least one mobile cation, the method comprising:
heating the ceramic body to a treatment temperature;
contacting at least one surface of the ceramic body with at least one halogen-containing compound; and
reacting the at least one mobile cation with the at least one halogen-containing compound to produce a treated ceramic material comprising at least one of an alkali content of less than or equal to about 100 ppm by weight or an iron content of less than or equal to about 300 ppm by weight.

76. The method of claim 75, wherein the treatment temperature ranges from about 1000° C. to about 1500° C.

77. The method of claim 75, wherein the halogen-containing compound includes at least one of Br, Cl, or F.

78. The method of claim 75, wherein a molar ratio of halogen in the at least one halogen-containing compound to the total alkali content of the ceramic body ranges from about 5:1 to about 200:1.

79. The method according to claim 75, wherein a treatment time ranges from about 1 hour to about 1000 hours.
